(19) United States
(12) Patent Application Publication
(10) Pub. No.: US 2026/0102729 A1
(43) Pub. Date: Apr. 16, 2026

(54) SCRUBBING APPARATUS

(71) Applicant: Seung Hwan OH, Seoul (KR)

(72) Inventors: Seung Hwan OH, Seoul (KR); Gunho SHIN, Seoul (KR)

(21) Appl. No.: 19/338,234

(22) Filed: Sep. 24, 2025

Related U.S. Application Data
(63) Continuation of application No. PCT/KR2024/016362, filed on Oct. 25, 2024.

(30) Foreign Application Priority Data
Oct. 15, 2024 (KR) 10-2024-0140018

(51) Int. Cl. B01D 47/02; B01D 47/06

(52) U.S. Cl. CPC B01D 47/028; B01D 47/06

(57) ABSTRACT

The scrubbing apparatus of the present invention includes a scrubbing chamber defining a scrubbing space for scrubbing impurities, a gas injection pipe through which gas is injected into the scrubbing chamber, a gas discharge pipe through which gas is discharged outside the scrubbing chamber, a first scrubbing plate disposed in the scrubbing chamber, a plurality of first scrubbing holes penetrating the first scrubbing plate, a solution supply nozzle configured to supply a scrubbing solution, a first pressure gauge configured to measure a first pressure of the gas, and a first pressure controller configured to control the magnitude of the first pressure, wherein the gas ascends through the plurality of first scrubbing holes, bubbles are formed on the upper surface of the first scrubbing plate, and impurities are dissolved into the scrubbing solution at a portion where the bubbles and the scrubbing solution come into contact.

### TECHNICAL FIELD

The present invention relates to a scrubbing apparatus. Specifically, the present invention relates to a scrubbing apparatus that improves scrubbing efficiency by increasing the contact area between a scrubbing solution and gas, and enhances stability and reliability by controlling the pressure of gas injected into a scrubbing chamber and the pressure of gas discharged to the outside of the scrubbing chamber.

### BACKGROUND ART

In modern industries, various types of air pollutants are generated, many of which have extremely low permissible exposure limits for humans. Accordingly, removing air pollutants from gases emitted in various industrial fields before discharge is a critical issue.

Currently used air pollution prevention facilities include dust collectors and scrubbers, and they are installed considering their efficiency depending on the type of pollutant. Among these, scrubbers are widely used because they can simultaneously process dust, exhaust gas, and high-temperature gas.

Specifically, scrubbers are classified into dry, wet, and plasma types depending on the method of treating the exhaust gas, and wet scrubbers are used in a process that causes the exhaust gas to come into contact with a liquid to dissolve water-soluble components in the gas into the liquid.

In wet scrubbers, a cleaning solution is generally used to effectively remove harmful components of the exhaust gas. When the cleaning solution comes into contact with harmful components, it removes the harmful components through a chemical reaction such as neutralization, so the one that best reacts chemically with the harmful components of the emitted gas should be selected. The performance of the wet scrubber is determined by whether the solution containing the cleaning solution can efficiently contact the exhaust gas. Accordingly, in the related art, a filler is installed to ensure sufficient contact between the cleaning solution and the discharged gas, and a spray nozzle is employed to supply a cleaning solution having fine particles.

Recently, a technology that can improve the contact area between the scrubbing solution containing the cleaning solution and the exhaust gas has been studied.

### SUMMARY

### Technical Problem

The technical problem to be solved by the present invention is to provide a scrubbing apparatus that improves scrubbing efficiency by increasing the contact area between a scrubbing solution and gas, and enhances stability and reliability by controlling the pressure of gas injected into a scrubbing chamber and the pressure of gas discharged to the outside of the scrubbing chamber.

The problems that the present invention is trying to solve are not limited to the problems mentioned above, and other problems that are not mentioned can be clearly understood by those skilled in the art from the description below.

### Solution to Problem

A scrubbing apparatus according to some embodiments of the present invention for achieving the above technical problem comprises a scrubbing chamber defining a scrubbing space for scrubbing impurities contained in gas discharged from a process chamber, a gas injection pipe having one end connected to the scrubbing chamber and the other end connected to the process chamber, and through which the gas is injected into the scrubbing chamber, a gas discharge pipe connected to the scrubbing chamber, through which the gas is discharged to the outside of the scrubbing chamber, a first scrubbing plate disposed in the scrubbing chamber, a plurality of first scrubbing holes penetrating the first scrubbing plate, a solution supply nozzle configured to supply a scrubbing solution onto an upper surface of the first scrubbing plate, a first pressure gauge configured to measure a first pressure of the gas passing through the gas injection pipe, and a first pressure controller provided at a boundary between the gas injection pipe and the scrubbing chamber or within the gas injection pipe and configured to adjust a magnitude of the first pressure, wherein bubbles are formed on the upper surface of the first scrubbing plate as the gas ascends through the plurality of first scrubbing holes, and wherein the impurities are dissolved in the scrubbing solution at a portion where the bubbles and the scrubbing solution come into contact.

In some embodiments, wherein when an absolute value of the first pressure measured by the first pressure gauge is greater than a first set value, an RPM (rotations per minute) of the first pressure controller decreases, and wherein when the absolute value of the first pressure measured by the first pressure gauge is less than the first set value, the RPM of the first pressure controller increases.

Since the absolute value of the first pressure is maintained constant at the first set value, the scrubbing apparatus with improved stability and reliability may be provided.

In some embodiments, wherein the first set value is greater than 500 Pa and less than 2000 pa.

In some embodiments, wherein the RPM of the first pressure controller is determined by the following Equation 1 and Equation 2:

$$R 1 = A 1 {( P 1 - {P}_{s e t 1} )}^{n} \times {e}^{- B 1 ( P 1 - {P}_{s e t 1} )} + C 1 ( P 1 > {P}_{set 1} ) \qquad Equation 1$$

$$R 1 = A 2 {( {P}_{s e t 1} - P 1 )}^{n} \times {e}^{B 2 ( {P}_{s e t 1 - P 1} )} + C 2 ( {P}_{s e t 1} > P 1 ) \qquad Equation 2$$

wherein R1 is a rotation amount of the first pressure controller, A1, B1, C1, A2, B2, C2, and n are rational numbers each ranging from 0 to 10, P1 is the first pressure, Pₛₑₜ₁ is the first set value, and C1 and C2 are initial rotation amounts of the first pressure controller, respectively.

The scrubbing apparatus according to some embodiments further comprises a second pressure gauge configured to measure a second pressure of the gas passing through the gas discharge pipe, and a second pressure controller provided at a boundary between the gas discharge pipe and the scrubbing chamber or within the gas discharge pipe and configured to adjust a magnitude of the second pressure, wherein when an absolute value of the second pressure measured by the second pressure gauge is greater than a second set value, an RPM of the second pressure controller decreases, and wherein when the absolute value of the second pressure measured by the second pressure gauge is less than the second set value, the RPM of the second pressure controller increases.

Since the absolute value of the second pressure is maintained constant at the second set value, the scrubbing apparatus with improved stability and reliability may be provided.

In some embodiments, wherein a sum of the first set value and the second set value is equal to or greater than 1000 Pa and equal to or less than 4000 Pa.

In some embodiments, wherein the scrubbing space includes a first sub-space and a second sub-space separated by a separating wall, wherein the gas injection pipe is connected to the first sub-space, and wherein the gas discharge pipe is connected to the second sub-space.

In some embodiments, wherein the first scrubbing plate and the solution supply nozzle are provided in the second sub-space.

In some embodiments, wherein the first sub-space and the second sub-space are connected to each other at a lower part of the scrubbing chamber.

The scrubbing apparatus according to some embodiments further comprises a connection valve provided at an upper part of the separating wall and configured to be opened and closed and a third pressure gauge configured to measure a third pressure inside the first sub-space, wherein when an absolute value of the first pressure and an absolute value of the third pressure are equal, the connection valve is opened, such that the gas injected through the gas injection pipe passes through the connection valve and is directly discharged to the outside of the scrubbing chamber through the gas discharge pipe.

The scrubbing apparatus according to some embodiments further comprises a second pressure gauge configured to measure a second pressure of the gas passing through the gas discharge pipe, a second pressure controller provided at a boundary between the gas discharge pipe and the scrubbing chamber or within the gas discharge pipe and configured to adjust a magnitude of the second pressure, a connection valve provided at an upper part of the separating wall and configured to be opened and closed, and a fourth pressure gauge configured to measure a third pressure inside the second sub-space, wherein when an absolute value of the second pressure and an absolute value of the third pressure are equal, the connection valve is opened, such that the gas injected through the gas injection pipe passes through the connection valve and is directly discharged to the outside of the scrubbing chamber through the gas discharge pipe.

The scrubbing apparatus according to some embodiments further comprises a connection valve provided at an upper part of the separating wall and configured to be opened and closed, and a third pressure gauge configured to measure a third pressure inside the scrubbing space, wherein when an absolute value of the third pressure exceeds a third set value, the connection valve is opened, such that the gas injected through the gas injection pipe passes through the connection valve and is directly discharged through the gas discharge pipe.

In some embodiments, wherein a number of process chambers connected to the scrubbing chamber is variable, wherein when the number of process chambers connected to the scrubbing chamber increases, an RPM of the first pressure controller increases, and wherein when the number of process chambers connected to the scrubbing chamber decreases, the RPM of the first pressure controller decreases.

In some embodiments, wherein an RPM of the first pressure controller is determined by the following Equation 5 and Equation 6:

$$R 1 = A 5 {( N 1 - N 2 )}^{k} \times {e}^{B 5 ( N 1 - N 2 )} + C 5 \qquad Equation 5$$

$$R 1 = A 6 {( N 2 - N 1 )}^{k} \times {e}^{- B 6 ( N 2 - N 1 )} + C 6 \qquad Equation 6$$

wherein R1 is a rotation amount of the first pressure controller, A5, B5, C5, A6, B6, C6, and k are rational numbers each ranging from 0 to 10, N1 is a current number of process chambers connected to the scrubbing chamber, N2 is a previous number of process chambers connected to the scrubbing chamber, and C5 and C6 are initial rotation amounts of the first pressure controller, respectively.

Specific details of other embodiments are included in the specification and drawings.

### Effect of Invention

The scrubbing apparatus of the present invention includes at least one scrubbing plate. Scrubbing holes penetrating the scrubbing plate are formed in the scrubbing plate. As the gas ascends through the scrubbing holes, bubbles may be formed within the scrubbing solution flowing on an upper surface of the scrubbing plate.

As the bubbles are formed, the contact area between the scrubbing solution and the gas increases. Due to the increased contact area, hydrophilic impurities in the gas may be dissolved more effectively in the scrubbing solution. Accordingly, the gas from which impurities (contaminants) have been removed may be discharged to the outside of the scrubbing apparatus.

In addition, the scrubbing apparatus of the present invention further comprises a first pressure controller configured to control the pressure of gas passing through a gas injection pipe, and a second pressure controller configured to control the pressure of gas passing through a gas discharge pipe. By controlling the pressure of gas injected into the scrubbing chamber and the pressure of gas discharged to the outside of the scrubbing chamber, stability and reliability can be enhanced.

### BRIEF DESCRIPTION OF DRAWINGS

FIG. 1 is a drawing briefly explaining a scrubbing system including a scrubbing apparatus to some embodiments of the present invention.

FIG. 2 is an exemplary perspective view for explaining the scrubbing apparatus according to some embodiments of the present invention.

FIG. 3 is an exemplary cross-sectional view for explaining the scrubbing apparatus according to some embodiments of the present invention.

FIG. 4 is an exemplary drawing for explaining a first pressure controller of FIG. 3.

FIG. 5 is an enlarged view of the P area of FIG. 3.

FIGS. 6, 7, 8, 9, 10 and 11 are drawings for explaining the scrubbing apparatus according to some other embodiments of the present invention.

FIGS. 12, 13, 14 and 15 are drawings for explaining an operating method of a scrubbing apparatus according to some embodiments of the present invention.

### DETAILED DESCRIPTION OF EXEMPLARY EMBODIMENTS

Hereinafter, preferred embodiments of the present invention will be described in detail with reference to the accompanying drawings. The advantages and features of the present invention and the methods for achieving them will become apparent with reference to the embodiments described in detail below together with the accompanying drawings. However, the present invention is not limited to the embodiments described below, but may be implemented in various different forms, and these embodiments are provided only to make the invention of the present invention complete and to fully inform those skilled in the art of the scope of the invention, and the present invention is defined only by the scope of the claims. Like reference numerals refer to like elements throughout the specification.

In addition, the terminology used herein is for the purpose of describing embodiments, and is not intended to limit and/or restrict the disclosed invention. The singular expression includes the plural expression unless the context clearly indicates otherwise. In this specification, the terms “comprises”, “include”, or “has” and the like are intended to specify that a feature, number, step, operation, component, part, or combination thereof described in the specification is present, but do not exclude in advance the possibility of the presence or addition of one or more other features, numbers, steps, operations, components, parts, or combinations thereof.

In addition, terms including ordinal numbers such as “first”, “second”, etc. used in this specification may be used to describe various components, but the components are not limited by the terms, and the terms are used only for the purpose of distinguishing one component from another. For example, without departing from the scope of the present invention, the first component may be named the second component, and similarly, the second component may also be named the first component. The term “and/or” includes a combination of multiple related described items or any item among multiple related described items.

Meanwhile, the terms “front”, “rear”, “upper”, “lower”, “front”, and “lower” used in the following description are defined based on the drawings, and the shape and position of each component are not limited by these terms.

The terms used in this specification are for describing embodiments and are not intended to limit the present invention. In this specification, the singular includes the plural unless specifically stated in the phrase. The terms “comprise” and/or “comprising” used in the specification do not exclude the presence or addition of one or more other components, steps, operations, and/or elements mentioned.

Unless otherwise defined, all terms (including technical and scientific terms) used in this specification may be used in a meaning that can be commonly understood by a person of ordinary skill in the art to which the present invention belongs. In addition, terms defined in commonly used dictionaries shall not be ideally or excessively interpreted unless explicitly specifically defined.

Hereinafter, embodiments of the present invention will be described in detail with reference to the attached drawings, and when describing with reference to the attached drawings, identical or corresponding components will be given the same reference numerals regardless of the drawing numbers, and redundant descriptions thereof will be omitted.

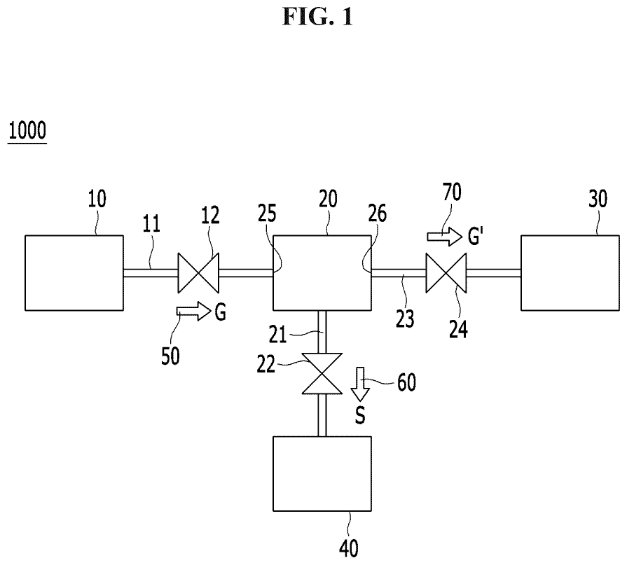

Hereinafter, first, a scrubbing system 1000 including a scrubbing apparatus 20 according to some embodiments of the present invention will be described with reference to FIG. 1. FIG. 1 is a drawing briefly explaining the scrubbing system including the scrubbing apparatus according to some embodiments of the present invention.

Referring to FIG. 1, the scrubbing system 1000 according to some embodiments of the present invention may include a process chamber 10, a scrubbing apparatus 20, an exhaust gas discharge chamber 30, and a scrubbing solution discharge chamber 40.

The process chamber 10 may be a chamber utilized in various industrial fields. The various industrial fields may be a plant field, a battery field, a thermal power plant field, a steel field, a semiconductor field, a chemical field, and/or an oil and gas plant field.

If the scrubbing system 1000 is utilized in the semiconductor field, the process chamber 10 may be a chamber in which a semiconductor process is performed. In order to manufacture a semiconductor device, various semiconductor processes must be performed on a wafer. For example, a film must be deposited on the wafer (deposition process), and the film must be etched (etching process) to form a pattern included in the semiconductor device. In addition, after the deposition process and/or the etching process are performed, a cleaning process must be performed to clean the wafer and/or the process chamber 10.

The deposition process may include, for example, physical vapor deposition (PVD), chemical vapor deposition (CVD), and/or atomic layer deposition (ALD). The etching process may include, for example, a dry etching process, a wet etching process, and/or an ashing process. The cleaning process may include, for example, a wet cleaning process, a dry cleaning process, and/or a vapor cleaning process.

If the scrubbing system 1000 is utilized in the oil and gas plant industry, the process chamber 10 may be a chamber where the plant process is performed.

When various processes are performed in the process chamber 10, various byproducts may be generated. The byproducts may include substances harmful to the human body, and if the byproducts include substances harmful to the human body, they must be removed and discharged. The scrubbing apparatus 20 may be used to remove substances harmful to the human body and the byproducts generated in the process chamber 10.

A gas injection pipe 11 may be disposed between the process chamber 10 and the scrubbing apparatus 20. One end of the gas injection pipe 11 may be connected to the process chamber 10, and the other end of the gas injection pipe 11 may be connected to the scrubbing apparatus 20. A gas G discharged from the process chamber 10 may be provided to the scrubbing apparatus 20 through the gas injection pipe 11 (see reference numeral 50). The gas G may contain impurities. The impurities may be substances harmful to the human body. The impurities may contain hydrophilic substances.

In some embodiments, a first valve 12 may be connected to the gas injection pipe 11. The first valve 12 may control the pressure and flow rate of the gas G provided to the scrubbing apparatus 20 through the gas injection pipe 11.

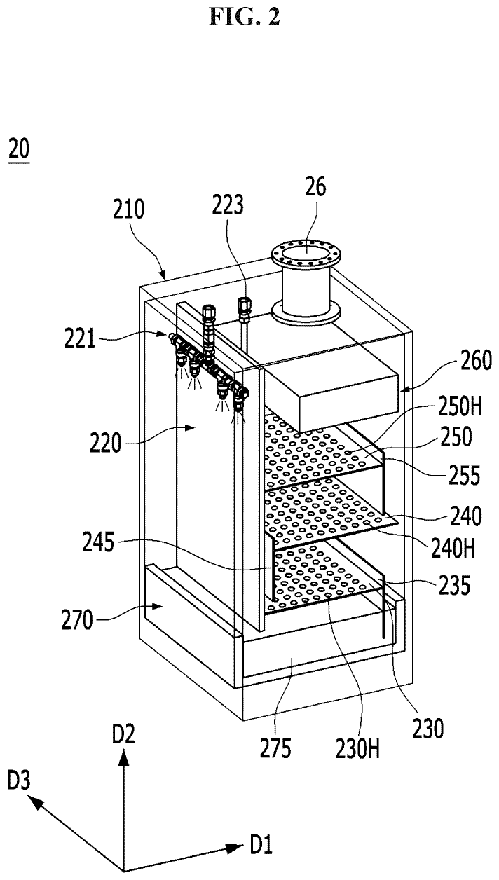

The scrubbing apparatus 20 may scrub the gas G provided from the process chamber 10. The impurities contained in the gas G may be dissolved in a scrubbing solution and stored in the scrubbing solution discharge chamber 40. The gas G′ from which the impurities have been removed may be stored in the exhaust gas discharge chamber 30. A detailed description of the scrubbing apparatus 20 will be described later using FIGS. 2 to 11.

The scrubbing solution discharge chamber 40 may be connected to the scrubbing apparatus 20. The scrubbing solution discharge chamber 40 and the scrubbing apparatus 20 may be connected to each other through a first pipe 21. One end of the first pipe 21 may be connected to the scrubbing apparatus 20, and the other end of the first pipe 21 may be connected the scrubbing solution discharge chamber 40. Through the first pipe 21, the scrubbing solution S in which impurities are dissolved may move from the scrubbing apparatus 20 to the scrubbing solution discharge chamber 40 (see reference numeral 60).

In some embodiments, a second valve 22 may be connected to the first pipe 21. The second valve 22 may control the pressure and flow rate of the scrubbing solution S containing dissolved impurities, which is supplied to the scrubbing solution discharge chamber 40 through the first pipe 21.

The exhaust gas discharge chamber 30 may be connected to the scrubbing apparatus 20. The exhaust gas discharge chamber 30 and the scrubbing apparatus 20 may be connected to each other through a gas discharge pipe 23. One end of the gas discharge pipe 23 may be connected to the scrubbing apparatus 20, and the other end of the gas discharge pipe 23 may be connected to the exhaust gas discharge chamber 30. Through the gas discharge pipe 23, the gas G′ from which impurities have been removed may move from the scrubbing apparatus 20 to the exhaust gas discharge chamber 30 (see reference numeral 70).

In some embodiments, a third valve 24 may be connected to the gas discharge pipe 23. The third valve 24 may control the pressure and flow rate of the gas G′ from which impurities have been removed and provided to the exhaust gas discharge chamber 30 through the gas discharge pipe 23.

In some embodiments, the scrubbing apparatus 20 may further include a gas inlet port 25 and a gas outlet port 26. The gas G may be introduced into the scrubbing apparatus 20 through the gas inlet port 25. The gas G′ from which impurities have been removed may be discharged to the exterior of the scrubbing apparatus 20 through the gas outlet port 26.

When the scrubbing apparatus 20 according to some embodiments of the present invention is utilized in the industrial field, pollutants generated after the process may be effectively separated and removed. Accordingly, environmental pollution problems may be reduced.

Hereinafter, a scrubbing apparatus according to some embodiments of the present invention will be described in detail with reference to FIGS. 2 to 5.

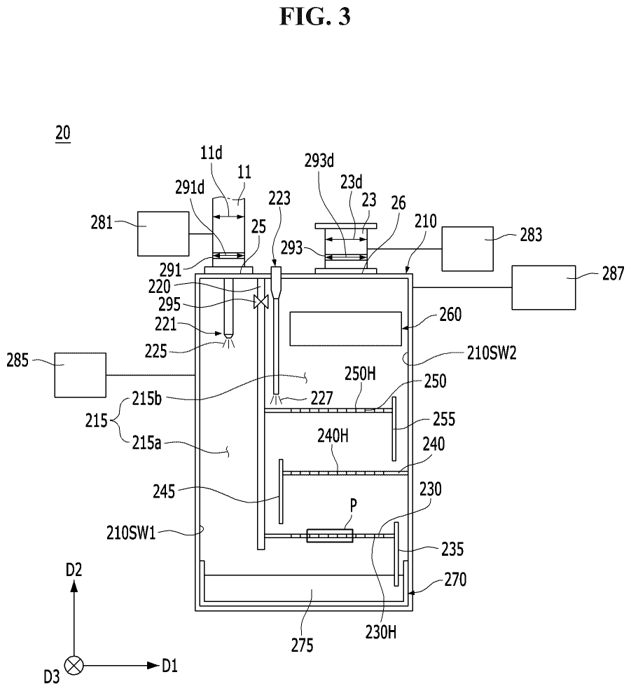

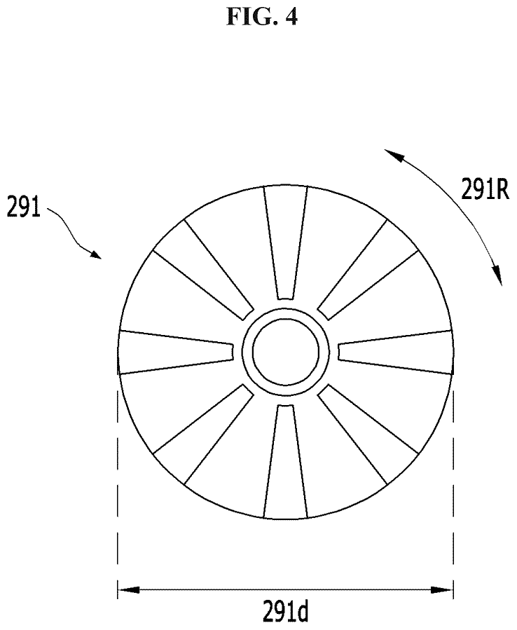

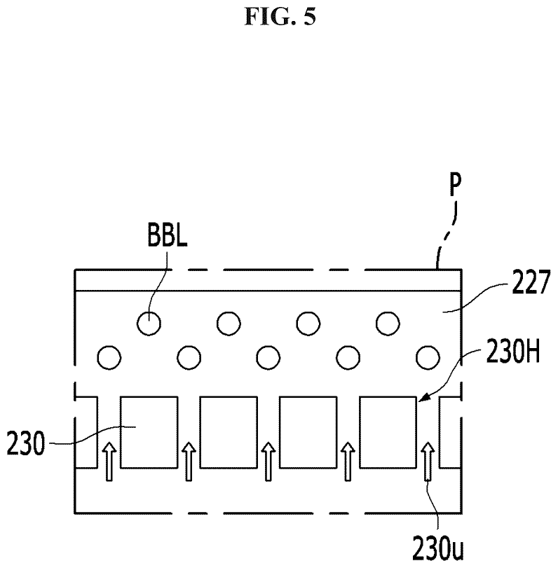

FIG. 2 is an exemplary perspective view for explaining the scrubbing apparatus according to some embodiments of the present invention. FIG. 3 is an exemplary cross-sectional view for explaining the scrubbing apparatus according to some embodiments of the present invention. FIG. 4 is an exemplary drawing for explaining a first pressure controller of FIG. 3. FIG. 5 is an enlarged view of the P area of FIG. 3.

Referring to FIGS. 2 to 5, the scrubbing apparatus 20 according to some embodiment of the present invention may include a scrubbing chamber 210, a separating wall 220, a first scrubbing plate 230, a second scrubbing plate 240, a third scrubbing plate 250, a spray nozzle 221, a solution supply nozzle 223, the gas injection pipe 11, the gas discharge pipe 23, a first pressure controller 291, a second pressure controller 293, a first pressure gauge 281, a second pressure gauge 283, a third pressure gauge 285, a connection valve 295, and a demister 260.

First, the scrubbing chamber 210 may be provided. The scrubbing chamber 210 may serve as an outer housing of the scrubbing apparatus 20. The gas (G of FIG. 1) may be introduced into the scrubbing chamber 210. The gas may contain impurities.

For example, the gas (G of FIG. 1) may be supplied into the scrubbing chamber 210 through the gas injection pipe 11. The gas injection pipe 11 may be formed at an upper wall of the scrubbing chamber 210 or at a side wall of the scrubbing chamber 210. In addition, the gas injection pipe 11 may be formed at an upper part of the side wall or at a lower part of the side wall of the scrubbing chamber 210.

The impurities contained in the gas (G of FIG. 1) may be dissolved in a scrubbing solution inside the scrubbing chamber 210. The scrubbing chamber 210 may define a scrubbing space 215. The scrubbing space 215 may be a space in which a scrubbing process is performed, in which impurities contained in the gas (G of FIG. 1) are dissolved in the scrubbing solution.

In some embodiments, the scrubbing space 215 may include a first sub-space 215a and a second sub-space 215b. The first sub-space 215a and the second sub-space 215b may be separated by the separating wall 220. The first sub-space 215a and the second sub-space 215b may be defined by the separating wall 220.

The separating wall 220 may be disposed inside the scrubbing chamber 210. In some embodiments, the separating wall 220 may be attached to an upper wall of the scrubbing chamber 210. The separating wall 220 may extend from the upper wall of the scrubbing chamber 210 in a second direction D2. The second direction D2 may be a direction perpendicular to the ground.

In some embodiments, the separating wall 220 may have a bar shape in a planar view. The separating wall 220 may extend in a third direction D3 in the planar view. One end of the separating wall 220 may be connected in contact with a third inner side wall of the scrubbing chamber 210, and the other end may be connected in contact with a fourth inner side wall of the scrubbing chamber 210. The separating wall 220 may include a long side extending in the third direction D3 and a short side extending in a first direction D1. However, the technical scope of the present invention is not limited thereto.

In some embodiments, the scrubbing chamber 210 may include a first inner side wall 210SW1, a second inner side wall 210SW2, the third inner side wall, and the fourth inner side wall.

The first inner side wall 210SW1 of the scrubbing chamber 210 may face the separating wall 220. The second inner side wall 210SW2 of the scrubbing chamber 210 may face the first inner side wall 210SW1 in the first direction D1. The third inner side wall and the fourth inner side wall may face each other in the third direction D3 and may intersect with the first inner side wall 210SW1 and the second inner side wall 210SW2, respectively.

The separating wall 220 may define the first sub-space 215a and the second sub-space 215b. The separating wall 220 may divide the scrubbing space 215 into the first sub-space 215a and the second sub-space 215b.

A first scrubbing process may be performed in the first sub-space 215a. A second scrubbing process may be performed in the second sub-space 215b. The first scrubbing process may be a process in which a portion of impurities is dissolved in the first scrubbing solution 225. The second scrubbing process may be a process in which another portion of the impurities is dissolved in the second scrubbing solution 227.

In the present specification, the first direction D1 and the third direction D3 may intersect with each other. The first direction D1 and the second direction D2 may intersect with each other. The second direction D2 and the third direction D3 may intersect with each other. That is, in the present specification, the first direction D1, the second direction D2, and the third direction D3 may be substantially perpendicular to one another.

The first scrubbing plate 230, the second scrubbing plate 240, and the third scrubbing plate 250 may be disposed in the scrubbing space 215. Specifically, the first scrubbing plate 230, the second scrubbing plate 240, and the third scrubbing plate 250 may be disposed in the second sub-space 215b.

Referring to FIGS. 2 to 5, the scrubbing apparatus 20 of the present invention is illustrated as including three scrubbing plates. However, the technical scope of the present invention is not limited thereto. The scrubbing apparatus 20 according to some embodiments of the present invention may include one or more scrubbing plates. That is, one scrubbing plate may be disposed in the second sub-space 215b, two scrubbing plates may be disposed, or four or more scrubbing plates may be disposed, as a matter of course.

The first scrubbing plate 230 may be disposed at a lowest part among the scrubbing plates disposed in the second sub-space 215b. One end of the first scrubbing plate 230 may be fixed by being connected to the separating wall 220. Specifically, one end of the first scrubbing plate 230 may be fixed by being connected to a side wall of the separating wall 220 that faces the second sub-space 215b. The first scrubbing plate 230 may extend in the first direction D1 while being connected to the separating wall 220, intersecting the separating wall 220. More specifically, the first scrubbing plate 230 may lie on a plane defined by the first direction D1 and the third direction D3.

In some embodiments, another portion of the first scrubbing plate 230 may be fixed by being connected to inner side walls of the scrubbing chamber 210. Specifically, the first scrubbing plate 230 may be connected to the separating wall 220, the third inner side wall of the scrubbing chamber 210, and the fourth inner side wall of the scrubbing chamber 210 in the second sub-space 215b.

However, the first scrubbing plate 230 may not be fixed by being connected to the second inner side wall 210SW2 of the scrubbing chamber 210. The first scrubbing plate 230 may be spaced apart from the second inner side wall 210SW2 of the scrubbing chamber 210 in the first direction D1. A space between the other end of the first scrubbing plate 230 and the second inner side wall 210SW2 of the scrubbing chamber 210 may be a space through which the second scrubbing solution 227, which will be described later, flows downward (e.g., in the second direction D2).

The scrubbing apparatus 20 according to some embodiments may further include a first scrubbing hole 230H and a first scrubbing wall 235.

The first scrubbing hole 230H may be formed in the first scrubbing plate 230. The first scrubbing hole 230H may extend from a lower surface of the first scrubbing plate 230 to an upper surface of the first scrubbing plate 230. That is, the first scrubbing hole 230H may penetrate the first scrubbing plate 230 in the second direction D2. The gas (G of FIG. 1) may ascend in the second direction D2 through the first scrubbing hole 230H (see reference numeral 230u).

The upper surface of the first scrubbing plate 230 may face the demister 260, which will be described later, and the lower surface of the first scrubbing plate 230 may face a scrubbing solution storage tank 270, which will also be described later.

The first scrubbing wall 235 may be attached to the other end of the first scrubbing plate 230. The first scrubbing wall 235 may be interposed between the first scrubbing plate 230 and the second inner side wall 210SW2 of the scrubbing chamber 210. The first scrubbing wall 235 may extend in the second direction D2. In some embodiments, a portion of the first scrubbing wall 235 may protrude in the second direction D2 from the upper surface of the first scrubbing plate 230. Another portion of the first scrubbing wall 235 may protrude in the second direction D2 from the lower surface of the first scrubbing plate 230.

The length in the second direction D2 of the portion of the first scrubbing wall 235 that protrudes from the upper surface of the first scrubbing plate 230 may be smaller than the length in the second direction D2 of the portion that protrudes from the lower surface of the first scrubbing plate 230. However, the technical scope of the present invention is not limited thereto.

In some embodiments, at least a portion of the part of the first scrubbing wall 235 that protrudes in the second direction D2 from the lower surface of the first scrubbing plate 230 may be disposed in a scrubbing solution 275 in which impurities, which will be described later, are dissolved. However, the technical scope of the present invention is not limited thereto.

The second scrubbing plate 240 may be disposed on the first scrubbing plate 230. Specifically, the second scrubbing plate 240 may be disposed on the upper surface of the first scrubbing plate 230. One end of the second scrubbing plate 240 may be fixed by being connected to the second inner side wall 210SW2 of the scrubbing chamber 210. The second scrubbing plate 240 may extend in the first direction D1 while being connected to the second inner side wall 210SW2 of the scrubbing chamber 210, intersecting the second inner side wall. More specifically, the second scrubbing plate 240 may be disposed on a plane defined by the first direction D1 and the third direction D3.

Likewise, the second scrubbing plate 240 may be fixed by being connected to the third inner side wall and the fourth inner side wall of the scrubbing chamber 210. However, the other end of the second scrubbing plate 240 may not be fixed by being connected to the separating wall 220. The other end of the second scrubbing plate 240 may be spaced apart from the separating wall 220 in the first direction D1. A space between the other end of the second scrubbing plate 240 and the separating wall 220 may be a space through which the second scrubbing solution 227, which will be described later, flows downward (e.g., in the second direction D2).

The scrubbing apparatus 20 according to some embodiments may further include a second scrubbing hole 240H and a second scrubbing wall 245.

The second scrubbing hole 240H may be formed in the second scrubbing plate 240. The second scrubbing hole 240H may extend from a lower surface of the second scrubbing plate 240 to an upper surface of the second scrubbing plate 240. That is, the second scrubbing hole 240H may penetrate the second scrubbing plate 240 in the second direction D2. The gas (G of FIG. 1) may ascend in the second direction D2 through the second scrubbing hole 240H.

The upper surface of the second scrubbing plate 240 may face the demister 260, which will be described later, and the lower surface of the second scrubbing plate 240 may face the upper surface of the first scrubbing plate 230.

The second scrubbing wall 245 may be attached to the other end of the second scrubbing plate 240. The second scrubbing wall 245 may be interposed between the second scrubbing plate 240 and the separating wall 220. The second scrubbing wall 245 may extend in the second direction D2. In some embodiments, a portion of the second scrubbing wall 245 may protrude in the second direction D2 from the upper surface of the second scrubbing plate 240. Another portion of the second scrubbing wall 245 may protrude in the second direction D2 from the lower surface of the second scrubbing plate 240.

The length in the second direction D2 of the portion of the second scrubbing wall 245 that protrudes from the upper surface of the second scrubbing plate 240 may be smaller than the length in the second direction D2 of the portion that protrudes from the lower surface of the second scrubbing plate 240. However, the technical scope of the present invention is not limited thereto.

In some embodiments, the first scrubbing plate 230 and the second scrubbing plate 240 may not be completely overlapped in the second direction D2. The first scrubbing plate 230 and the second scrubbing plate 240 may be arranged in a zigzag manner. Accordingly, the second scrubbing solution 227 that flows downward beyond the second scrubbing wall 245 may be discharged onto the upper surface of the first scrubbing plate 230. In other words, a center of the first scrubbing plate 230 and a center of the second scrubbing plate 240 may be offset from each other.

The third scrubbing plate 250 may be disposed on the second scrubbing plate 240. Specifically, the third scrubbing plate 250 may be disposed on the upper surface of the second scrubbing plate 240. One end of the third scrubbing plate 250 may be fixed by being connected to the separating wall 220.

Specifically, one end of the third scrubbing plate 250 may be fixed by being connected to a side wall of the separating wall 220 that faces the second sub-space 215b. The third scrubbing plate 250 may extend in the first direction D1 while being connected to the separating wall 220, intersecting the separating wall 220. More specifically, the third scrubbing plate 250 may be disposed on a plane defined by the first direction D1 and the third direction D3. Likewise, the third scrubbing plate 250 may be fixed by being connected to the third inner side wall and the fourth inner side wall of the scrubbing chamber 210.

However, the other end of the third scrubbing plate 250 may not be fixed by being connected to the second inner side wall 210SW2 of the scrubbing chamber 210. The other end of the third scrubbing plate 250 may be spaced apart from the second inner side wall 210SW2 of the scrubbing chamber 210 in the first direction D1. A space between the other end of the third scrubbing plate 250 and the second inner side wall 210SW2 of the scrubbing chamber 210 may be a space through which the second scrubbing solution 227, which will be described later, flows downward (e.g., in the second direction D2).

The scrubbing apparatus 20 according to some embodiments may further include a third scrubbing hole 250H and a third scrubbing wall 255.

The third scrubbing hole 250H may be formed in the third scrubbing plate 250. The third scrubbing hole 250H may extend from a lower surface of the third scrubbing plate 250 to an upper surface of the third scrubbing plate 250. That is, the third scrubbing hole 250H may penetrate the third scrubbing plate 250 in the second direction D2. The gas (G of FIG. 1) may ascend in the second direction D2 through the third scrubbing hole 250H.

The upper surface of the third scrubbing plate 250 may face the demister 260, which will be described later, and the lower surface of the third scrubbing plate 250 may face the upper surface of the second scrubbing plate 240.

The third scrubbing wall 255 may be attached to the other end of the third scrubbing plate 250. The third scrubbing wall 255 may be interposed between the third scrubbing plate 250 and the second inner side wall 210SW2 of the scrubbing chamber 210. The third scrubbing wall 255 may extend in the second direction D2.

In some embodiments, a portion of the third scrubbing wall 255 may protrude in the second direction D2 from the upper surface of the third scrubbing plate 250. Another portion of the third scrubbing wall 255 may protrude in the second direction D2 from the lower surface of the third scrubbing plate 250.

The length in the second direction D2 of the portion of the third scrubbing wall 255 that protrudes from the upper surface of the third scrubbing plate 250 may be smaller than the length in the second direction D2 of the portion that protrudes from the lower surface of the third scrubbing plate 250. However, the technical scope of the present invention is not limited thereto.

In some embodiments, the third scrubbing plate 250 and the second scrubbing plate 240 may not be completely overlapped in the second direction D2. The third scrubbing plate 250 and the second scrubbing plate 240 may be arranged in a zigzag manner. The second scrubbing solution 227, which flows downward beyond the third scrubbing wall 255, may be discharged onto an upper surface of the second scrubbing plate 240. In other words, a center of the third scrubbing plate 250 and a center of the second scrubbing plate 240 may be offset from each other.

However, the third scrubbing plate 250 and the first scrubbing plate 230 may be completely overlapped in the second direction D2. That is, a center of the third scrubbing plate 250 and a center of the first scrubbing plate 230 may be overlapped with each other in the second direction D2.

In some embodiments, the first to third scrubbing holes 230H, 240H, and 250H may be completely overlapped in the second direction D2. However, the technical scope of the present invention is not limited thereto. The first to third scrubbing holes 230H, 240H, and 250H may not be completely overlapped in the second direction D2, and may be partially overlapped, as a matter of course.

In some embodiments, the second scrubbing solution 227 may be water. However, the technical scope of the present invention is not limited thereto.

The second scrubbing solution 227, after being discharged onto the upper surface of the third scrubbing plate 250, may flow toward the third scrubbing wall 255 on the upper surface of the third scrubbing plate 250 while the second scrubbing process is performed. In this case, the second scrubbing solution 227 does not flow downward through the third scrubbing hole 250H. Instead, the second scrubbing solution 227 may flow beyond the third scrubbing wall 255 toward the lower part of the scrubbing chamber 210.

The second scrubbing solution 227, after flowing beyond the third scrubbing wall 255, is discharged again onto the upper surface of the second scrubbing plate 240. The second scrubbing solution 227 may flow toward the second scrubbing wall 245 on the upper surface of the second scrubbing plate 240 while the second scrubbing process is performed.

The second scrubbing solution 227 placed on the upper surface of the second scrubbing plate 240 does not flow downward through the second scrubbing hole 240H. The second scrubbing solution 227 may flow beyond the second scrubbing wall 245 toward the lower part of the scrubbing chamber 210.

Likewise, the second scrubbing solution 227, after flowing beyond the second scrubbing wall 245, is discharged again onto the upper surface of the first scrubbing plate 230. The second scrubbing solution 227 may flow toward the first scrubbing wall 235 on the upper surface of the first scrubbing plate 230 while the second scrubbing process is performed.

In this case, the second scrubbing solution 227 does not flow downward through the first scrubbing hole 230H. The second scrubbing solution 227 may flow beyond the first scrubbing wall 235 toward the lower part of the scrubbing chamber 210.

Finally, the second scrubbing solution 227 that has flowed beyond the first scrubbing wall 235 may be stored in the scrubbing solution storage tank 270 provided at the lower part of the scrubbing chamber 210. The scrubbing solution 275 in which impurities are dissolved may be stored in the scrubbing solution storage tank 270. For example, the scrubbing solution 275 in which impurities are dissolved may be a solution in which a hydrophilic gas is dissolved in the second scrubbing solution 227.

In some embodiments, the hydrophilic gas may be IPA (isopropyl alcohol) and/or ammonia. However, the technical scope of the present invention is not limited thereto.

The demister 260 may be disposed at the upper part of the scrubbing chamber 210. The demister 260 may be used to remove moisture from gas after the first scrubbing process and the second scrubbing process have been performed. After the first scrubbing process and the second scrubbing process are performed, the gas G′ (G′ of FIG. 1) from which impurities have been removed may be provided. That is, the moisture in the gas G′, from which impurities have been removed through the first and second scrubbing processes, may be removed using the demister 260. The gas filtered through the demister 260 may be discharged to the outside of the scrubbing chamber 210 through a gas outlet 26 and the gas discharge pipe 23.

When the scrubbing apparatus 20 according to some embodiments is used, harmful gas to the human body (e.g., impurities) may be dissolved in the scrubbing solution. Accordingly, harmful gas generated as a by-product after various processes in various industrial fields may be removed and discharged to the outside of the scrubbing chamber 210.

In some embodiments, the first sub-space 215a may be defined by the first inner side wall 210SW1 of the scrubbing chamber 210 and the separating wall 220. For example, the first sub-space 215a may be defined by the first inner side wall 210SW1 of the scrubbing chamber 210, the third inner side wall of the scrubbing chamber 210, the fourth inner side wall of the scrubbing chamber 210, and the separating wall 220.

The first scrubbing process may be performed in the first sub-space 215a.

Specifically, the first scrubbing solution 225 may be supplied into the scrubbing chamber 210 through the spray nozzle 221. The first scrubbing solution 225 may be supplied into the first sub-space 215a through the spray nozzle 221.

The first scrubbing solution 225 is provided from an upper part to the lower part of the first sub-space 215a, and while the gas (G of FIG. 1) flows from the upper part to the lower part of the first sub-space 215a, at least a portion of impurities contained in the gas may be dissolved in the first scrubbing solution 225. In some embodiments, the first scrubbing solution 225 may include water. However, the technical scope of the present invention is not limited thereto.

In some embodiments, the spray nozzle 221 may be a spray-type nozzle. The spray nozzle 221 may supply the first scrubbing solution 225, having fine particles, into the first sub-space 215a. Accordingly, a contact area between the first scrubbing solution 225 and the gas may be increased. As a result, the scrubbing apparatus 20 with improved scrubbing efficiency may be provided.

The spray nozzle 221 may be installed at the upper part of the scrubbing chamber 210. Although not illustrated, the spray nozzle 221 may be connected to a pipe installed outside the scrubbing chamber 210.

In some embodiments, the gas inlet port 25 may be installed at one side of the first sub-space 215a. The gas inlet port 25 may be connected to the gas injection pipe 11.

The gas (G of FIG. 1) introduced into the scrubbing chamber 210 may be introduced through the gas injection pipe 11 and the gas inlet port 25. The gas inlet port 25 may be connected to the gas injection pipe 11, and since the other end of the gas injection pipe 11 is connected to a process chamber (10 of FIG. 1), the gas (G of FIG. 1) introduced through the gas inlet port 25 may be supplied from the process chamber.

In some embodiments, a negative pressure may be provided in the scrubbing space 215 through the gas inlet port 25 and the gas outlet port 26. For example, the gas pressure at the gas inlet port 25 and the gas pressure at the gas outlet port 26 may be different from each other. Accordingly, the gas (G of FIG. 1) may flow from the gas inlet port 25 toward the gas outlet port 26. The first scrubbing process and the second scrubbing process may be performed using a pressure difference between the gas at the gas inlet port 25 and the gas at the gas outlet port 26.

In some embodiments, the first pressure gauge 281 may measure a first pressure of the gas passing through the gas injection pipe 11. The second pressure gauge 283 may measure a second pressure of the gas passing through the gas discharge pipe 23. The third pressure gauge 285 and the fourth pressure gauge 287 may measure a third pressure of the gas in the scrubbing space 215. For example, the third pressure gauge 285 may measure the pressure of the gas in the first sub-space 215a, and the fourth pressure gauge 287 may measure the pressure of the gas in the second sub-space 215b.

The first pressure gauge 281 may be disposed at a front end of the first pressure controller 291. The front end of the first pressure controller 291 may refer to a position between the first pressure controller 291 and the process chamber (10 of FIG. 1). A rear end of the first pressure controller 291 may refer to a position between the first pressure controller 291 and the scrubbing chamber 210.

In some embodiments, the rear end of the first pressure controller 291 may be under positive pressure, and the front end of the first pressure controller 291 may be under negative pressure. However, the absolute value of the pressure measured at the rear end of the first pressure controller 291 and the absolute value of the pressure measured at the front end of the first pressure controller 291 may be substantially the same.

In some embodiments, the first pressure controller 291 may be installed within the gas injection pipe 11. The first pressure controller 291 may be fixed by being connected inside the gas injection pipe 11. In FIG. 4, the first pressure controller 291 may be a fan; however, the technical scope of the present invention is not limited thereto.

In some embodiments, the first pressure controller 291 may have a configuration in which the fan is disposed inside a separate housing. In this case, the housing may be fixed by being connected to an inner wall of the gas injection pipe 11. In other embodiments, the first pressure controller 291 may not include a separate housing. In this case, an outer portion of the fan may be fixed by being connected to the inner wall of the gas injection pipe 11. However, the technical scope of the present invention is not limited thereto.

The first pressure controller 291 may adjust a magnitude of the first pressure of the gas passing through the gas injection pipe 11. Specifically, the first pressure controller 291 may rotate in a clockwise or counterclockwise direction (see reference numeral 291R). By controlling a rotation amount of the first pressure controller 291, the magnitude of the first pressure of the gas passing through the gas injection pipe 11 may be adjusted.

In some embodiments, a width 291d of the first pressure controller 291 may be equal to or less than a width 11d of the gas injection pipe 11. This may be because the first pressure controller 291 is disposed inside the gas injection pipe 11.

In some embodiments, the width 291d of the first pressure controller 291 may be a diameter of the first pressure controller 291, and the width 11d of the gas injection pipe 11 may be a diameter of the gas injection pipe 11. However, the technical scope of the present invention is not limited thereto.

In some embodiments, since the width 291d of the first pressure controller 291 is equal to or less than the width 11d of the gas injection pipe 11, the first pressure of the gas passing through the gas injection pipe 11 may be precisely controlled according to the rotation amount of the first pressure controller 291. This may be because energy loss due to the rotation of the first pressure controller 291 inside the gas injection pipe 11 is minimal. However, the technical scope of the present invention is not limited thereto.

In some embodiments, when a magnitude of the first pressure measured by the first pressure gauge 281 is greater than a first set value, a rotation amount of the first pressure controller 291 may be decreased. Specifically, when an absolute value of the first pressure is greater than the first set value, the rotation amount of the first pressure controller 291 may be decreased. The magnitude of the first pressure may refer to the absolute value of the first pressure.

That is, when an absolute value of the first pressure measured by the first pressure gauge 281 is greater than the first set value, an RPM (rotations per minute) of the first pressure controller 291 may be decreased. The first set value may be equal to or greater than 500 Pa and equal to or less than 2000 Pa. However, the technical scope of the present invention is not limited thereto. Preferably, the first set value may be equal to or greater than 500 Pa and equal to or less than 1000 Pa.

This may be because the magnitude of the first pressure of the gas passing through the gas injection pipe 11 decreases when the rotation amount of the first pressure controller 291 decreases. A decrease in the magnitude of the first pressure of the gas passing through the gas injection pipe 11 may mean that the absolute value of the first pressure measured at the front end of the first pressure controller 291 decreases.

Such a relationship may be expressed by the following Equation 1.

$$R 1 = A 1 {( P 1 - {P}_{s e t 1} )}^{n} \times {e}^{- B 1 ( P 1 - {P}_{s e t 1} )} + C 1 ( P 1 > {P}_{set 1} ) \qquad Equation 1$$

Here, R1 may be a rotation amount and/or an RPM of the first pressure controller 291. A1, B1, C1, and n may each be constants. Specifically, C1 may be an initial rotation amount of the first pressure controller 291. The initial rotation amount may be zero; however, the technical scope of the present invention is not limited thereto. P1 may be the first pressure measured by the first pressure gauge 281. Pₛₑₜ₁ may be the first set value. The values n, A1, and B1 may each be rational numbers ranging from 0 to 10.

According to Equation 1, the greater the absolute value of the first pressure compared to the first set value, the more rapidly the RPM of the first pressure controller 291 may decrease. This may be to more quickly adjust the absolute value of the first pressure to be equal to the first set value as the difference between the absolute value of the first pressure and the first set value increases. Accordingly, the scrubbing apparatus with improved reliability may be provided.

Conversely, when an absolute value of the first pressure measured by the first pressure gauge 281 is less than the first set value, a rotation amount of the first pressure controller 291 may be increased. That is, when the absolute value of the first pressure measured by the first pressure gauge 281 is less than the first set value, an RPM (rotations per minute) of the first pressure controller 291 may be increased.

This may be because, when the rotation amount of the first pressure controller 291 increases, the magnitude of the first pressure of the gas passing through the gas injection pipe 11 increases. An increase in the magnitude of the first pressure of the gas passing through the gas injection pipe 11 may mean that the absolute value of the first pressure measured at the front end of the first pressure controller 291 increases.

Such a relationship may be expressed by the following Equation 2.

$$R 1 = A 2 {( {P}_{s e t 1} - P 1 )}^{n} \times {e}^{B 2 ( {P}_{s e t 1 - P 1} )} + C 2 ( {P}_{s e t 1} > P 1 ) \qquad Equation 2$$

Here, R1 may be a rotation amount and/or an RPM of the first pressure controller 291. A2, B2, C2, and n may each be constants. Specifically, C2 may be an initial rotation amount of the first pressure controller 291. The initial rotation amount may be zero; however, the technical scope of the present invention is not limited thereto. P1 may be the first pressure measured by the first pressure gauge 281. Pₛₑₜ₁ may be the first set value. The values n, A2, and B2 may each be rational numbers ranging from 0 to 10.

According to Equation 2, the smaller the absolute value of the first pressure compared to the first set value, the more rapidly the RPM of the first pressure controller 291 may increase. This may be to more quickly adjust the absolute value of the first pressure to be equal to the first set value as the difference between the absolute value of the first pressure and the first set value increases. Accordingly, the scrubbing apparatus with improved reliability may be provided.

By using the first pressure controller 291 and the second pressure controller 293, the absolute value of the first pressure and the absolute value of the second pressure may be controlled to remain constant. The absolute value of the first pressure may be maintained within a range of 500 Pa to 2000 Pa. If the absolute value of the first pressure is less than 500 Pa, the efficiency of the process chamber connected to the scrubbing apparatus may decrease. If the absolute value of the first pressure is greater than 2000 Pa, the process chamber connected to the scrubbing apparatus may malfunction. Accordingly, the scrubbing apparatus 20 with improved reliability may be provided.

In some embodiments, the second pressure gauge 283 may measure a second pressure of the gas passing through the gas discharge pipe 23.

The second pressure gauge 283 may be disposed at a rear end of the second pressure controller 293. The rear end of the second pressure controller 293 may be a position between the second pressure controller 293 and an exhaust gas discharge chamber (30 of FIG. 1). A front end of the second pressure controller 293 may be a position between the second pressure controller 293 and the scrubbing chamber 210.

In some embodiments, the rear end of the second pressure controller 293 may be under positive pressure, and the front end of the second pressure controller 293 may be under negative pressure. However, the absolute value of the pressure measured at the rear end of the second pressure controller 293 and the absolute value of the pressure measured at the front end of the second pressure controller 293 may be substantially the same.

In some embodiments, the second pressure controller 293 may be installed within the gas discharge pipe 23. The second pressure controller 293 may be fixed by being connected inside the gas discharge pipe 23. For example, the second pressure controller 293 may be a fan; however, the technical scope of the present invention is not limited thereto. The first pressure controller 291 and the second pressure controller 293 may be substantially identical.

In some embodiments, the second pressure controller 293 may have a configuration in which the fan is disposed inside a separate housing. In this case, the housing may be fixed by being connected to an inner wall of the gas discharge pipe 23. In another example, the second pressure controller 293 may not include a separate housing. In this case, an outer portion of the fan may be fixed by being connected to the inner wall of the gas discharge pipe 23. However, the technical scope of the present invention is not limited thereto.

The second pressure controller 293 may adjust a magnitude of the second pressure of the gas passing through the gas discharge pipe 23. Specifically, the magnitude of the second pressure may be adjusted by controlling a rotation amount of the second pressure controller 293.

In some embodiments, a width 293d of the second pressure controller 293 may be equal to or less than a width 23d of the gas discharge pipe 23. This may be because the second pressure controller 293 is disposed inside the gas discharge pipe 23.

In some embodiments, the width 293d of the second pressure controller 293 may be a diameter of the second pressure controller 293, and the width 23d of the gas discharge pipe 23 may be a diameter of the gas discharge pipe 23. However, the technical scope of the present invention is not limited thereto.

In some embodiments, since the width 293d of the second pressure controller 293 is equal to or less than the width 23d of the gas discharge pipe 23, the second pressure of the gas passing through the gas discharge pipe 23 may be precisely controlled according to the rotation amount of the second pressure controller 293. This may be because energy loss caused by the rotation of the second pressure controller 293 inside the gas discharge pipe 23 is minimal. However, the technical scope of the present invention is not limited thereto.

In some embodiments, when an absolute value of the second pressure measured by the second pressure gauge 283 is greater than a second set value, a rotation amount of the second pressure controller 293 may be decreased. That is, when the absolute value of the second pressure measured by the second pressure gauge 283 is greater than the second set value, an RPM (rotations per minute) of the second pressure controller 293 may be decreased. The second set value may be equal to or greater than 500 Pa and equal to or less than 2000 Pa. However, the technical scope of the present invention is not limited thereto. Preferably, the second set value may be equal to or greater than 500 Pa and equal to or less than 1000 Pa.

For example, the sum of the first set value and the second set value may be equal to or greater than 1000 Pa and equal to or less than 4000 Pa. However, the technical scope of the present invention is not limited thereto. Preferably, the sum of the first set value and the second set value may be equal to or greater than 1000 Pa and equal to or less than 2000 Pa.

This may be because, when the rotation amount of the second pressure controller 293 decreases, the magnitude of the second pressure of the gas passing through the gas discharge pipe 23 decreases. A decrease in the magnitude of the second pressure of the gas passing through the gas discharge pipe 23 may mean that the absolute value of the second pressure measured at the rear end of the second pressure controller 293 decreases.

Such a relationship may be expressed by the following Equation 3.

$$R 2 = A 3 {( P 2 - {P}_{s e t 2} )}^{n} \times {e}^{- B 3 ( P 2 - {P}_{s e t 2} )} + C 3 \qquad Equation 3$$

Here, R2 may be a rotation amount and/or an RPM of the second pressure controller 293. A3, B3, C3, and n may each be constants. Specifically, C3 may be an initial rotation amount of the second pressure controller 293. The initial rotation amount may be zero; however, the technical scope of the present invention is not limited thereto. P2 may be the second pressure measured by the second pressure gauge 283. Pₛₑₜ₂ may be the second set value. The values n, A3, and B3 may each be rational numbers ranging from 0 to 10.

According to Equation 3, the greater the absolute value of the second pressure compared to the second set value, the more rapidly the RPM of the second pressure controller 293 may decrease. This may be to more quickly adjust the absolute value of the second pressure to be equal to the second set value as the difference between the absolute value of the second pressure and the second set value increases. Accordingly, the scrubbing apparatus with improved reliability may be provided.

Conversely, when an absolute value of the second pressure measured by the second pressure gauge 283 is less than the second set value, a rotation amount of the second pressure controller 293 may be increased. That is, when the absolute value of the second pressure measured by the second pressure gauge 283 is less than the second set value, an RPM (rotations per minute) of the second pressure controller 293 may be increased.

This may be because, when the rotation amount of the second pressure controller 293 increases, the magnitude of the second pressure of the gas passing through the gas discharge pipe 23 increases. An increase in the magnitude of the second pressure of the gas passing through the gas discharge pipe 23 may mean that the absolute value of the second pressure measured at the rear end of the second pressure controller 293 increases.

Such a relationship may be expressed by the following Equation 4.

$$R 2 = A 4 {( {P}_{s e t 2} - P 2 )}^{n} \times {e}^{B 4 ( {P}_{s e t 2 - P 2} )} + C 4 \qquad Equation 4$$

Here, R2 may be the rotation amount and/or the RPM (rotations per minute) of the second pressure controller 293. A4, B4, C4, and n may each be a constant. Specifically, C4 may be an initial rotation amount of the second pressure controller 293. The initial rotation amount may be zero; however, the technical scope of the present invention is not limited thereto. P2 may be the second pressure measured by the second pressure gauge 283. Pₛₑₜ₂ may be the second set value. Each of n, A4, and B4 may be a rational number between 0 and 10.

According to Equation 4, the smaller the absolute value of the second pressure compared to the second set value, the more rapidly the RPM of the second pressure controller 293 may increase. This may be to more quickly adjust the absolute value of the second pressure to be equal to the second set value when the difference between the absolute value of the second pressure and the second set value is large. Accordingly, the scrubbing apparatus with improved reliability may be provided.

The first pressure controller 291 and the second pressure controller 293 may be used to maintain the first pressure and the second pressure at constant levels. Accordingly, the scrubbing apparatus 20 with improved reliability may be provided.

In some embodiments, the connection valve 295 may be installed on the upper portion of the separating wall 220. The connection valve 295 may be openable and closable. When the connection valve 295 is opened, the gas introduced through the gas injection pipe 11 may be directly discharged to the gas discharge pipe 23 through the connection valve 295. When the connection valve 295 is closed, the gas introduced through the gas injection pipe 11 may be scrubbed while passing through the first sub-space 215a and the second sub-space 215b.

In some embodiments, the connection valve 295 may be opened or closed depending on the pressure of the gas within the scrubbing space 215. That is, the opening or closing of the connection valve 295 may be determined based on the pressure of the gas within the scrubbing space 215.

For example, the third pressure gauge 285 and the fourth pressure gauge 287 may measure a third pressure of the gas within the scrubbing space 215. The third pressure may be the pressure of the gas in the first sub-space 215a or the pressure of the gas in the second sub-space 215b. The third pressure gauge 285 may measure the pressure of the gas in the first sub-space 215a, and the fourth pressure gauge 287 may measure the pressure of the gas in the second sub-space 215b.

When the absolute value of the third pressure exceeds a third set value, the connection valve 295 may open. The third set value may be similar to the absolute value of the first pressure or the absolute value of the second pressure. For example, the third set value may range from 500 Pa to 2000 Pa; however, the technical scope of the present invention is not limited thereto. Preferably, the third set value may range from 500 Pa to 1000 Pa. It is to be understood that the third set value may be different from each of the first set value and the second set value.

For example, when the absolute value of the third pressure is measured by the third pressure gauge 285, the third set value may be substantially equal to the absolute value of the first pressure. In another example, when the absolute value of the third pressure is measured by the fourth pressure gauge 287, the third set value may be substantially equal to the absolute value of the second pressure.

When the difference between the absolute value of the first pressure and the absolute value of the third pressure decreases, the force driving the gas to pass through the scrubbing holes 230H, 240H, and 250H may be reduced. In this case, the gas may not be scrubbed efficiently. Accordingly, when the third pressure exceeds the third set value, the connection valve 295 may open, and the gas injected through the gas injection pipe 11 may be directly discharged through the gas discharge pipe 23. As a result, the scrubbing apparatus with improved efficiency may be provided.

In addition, when the difference between the absolute value of the second pressure and the absolute value of the third pressure decreases, the force driving the gas to pass through the scrubbing holes 230H, 240H, and 250H may be reduced. In this case, the gas may not be scrubbed efficiently. Accordingly, when the third pressure exceeds the third set value, the connection valve 295 may open, and the gas injected through the gas injection pipe 11 may be directly discharged through the gas discharge pipe 23. As a result, a scrubbing apparatus capable of responding to abnormal operating conditions may be provided. That is, the connection valve 295 may serve as a protection device capable of coping with abnormal operating states.

In some embodiments, the first sub-space 215a and the second sub-space 215b may be connected to each other at a lower part of the scrubbing chamber 210. The first sub-space 215a and the second sub-space 215b may be connected to each other above the scrubbing solution storage tank 270.

That is, the gas introduced into the first sub-space 215a may flow from the upper part to the lower part of the first sub-space 215a and may be introduced into the second sub-space 215b at the lower part of the scrubbing chamber 210. In the second sub-space 215b, the gas (G of FIG. 1) may ascend in the second direction D2.

When the scrubbing device 20 according to some embodiments is used, the contact area between the gas and the scrubbing solution may be increased. Specifically, bubbles may be formed in the scrubbing solution to increase the contact area between the scrubbing solution and the gas.

For example, in FIG. 5, the gas (G of FIG. 1) may ascend in the second direction D2 through the first scrubbing hole 230H (see reference numeral 230u).

After the gas (G of FIG. 1) ascends through the first scrubbing hole 230H, a bubble BBL may be formed on the upper surface of the first scrubbing plate 230. The bubble BBL may be formed inside the second scrubbing solution 227. The bubble BBL may be a gas bubble generated inside the second scrubbing solution 227 due to the pressure of the gas attempting to ascend in the second direction D2.

The impurities contained in the gas may be dissolved in the second scrubbing solution 227 at the interface where the bubble BBL comes into contact with the second scrubbing solution 227.

Subsequently, the gas (G of FIG. 1) may ascend in the second direction D2 by passing upward through the second scrubbing hole 240H after passing upward through the first scrubbing hole 230H.

After the gas (G of FIG. 1) passes upward through the second scrubbing hole 240H, another bubble may be formed on the upper surface of the second scrubbing plate 240. The other bubble may be formed in the second scrubbing solution 227. The other bubble may be a gas bubble generated due to the pressure of the gas attempting to ascend in the second direction D2 within the second scrubbing solution 227.

The impurities contained in the gas may be dissolved into the second scrubbing solution 227 at a portion where the other bubble comes into contact with the second scrubbing solution 227.

Likewise, the gas (G of FIG. 1) may ascend in the second direction D2 through the third scrubbing hole 250H after ascending through the second scrubbing hole 240H. After the gas (G of FIG. 1) ascends through the third scrubbing hole 250H, yet another bubble may be formed on the upper surface of the third scrubbing plate 250.

After the gas (G of FIG. 1) ascends through the third scrubbing hole 250H, the yet another bubble may be formed on the upper surface of the third scrubbing plate 250. The yet another bubble may be formed in the second scrubbing solution 227. The yet another bubble may be a gas bubble generated in the second scrubbing solution 227 due to the pressure of the gas ascending in the second direction D2.

The impurities contained in the gas may be dissolved in the second scrubbing solution 227 at a portion where the yet another bubble comes into contact with the second scrubbing solution 227.

When the bubbles are formed in the second scrubbing solution 227, a contact area between the gas and the scrubbing solution may be increased. Accordingly, a scrubbing apparatus 20 with improved scrubbing efficiency may be provided.

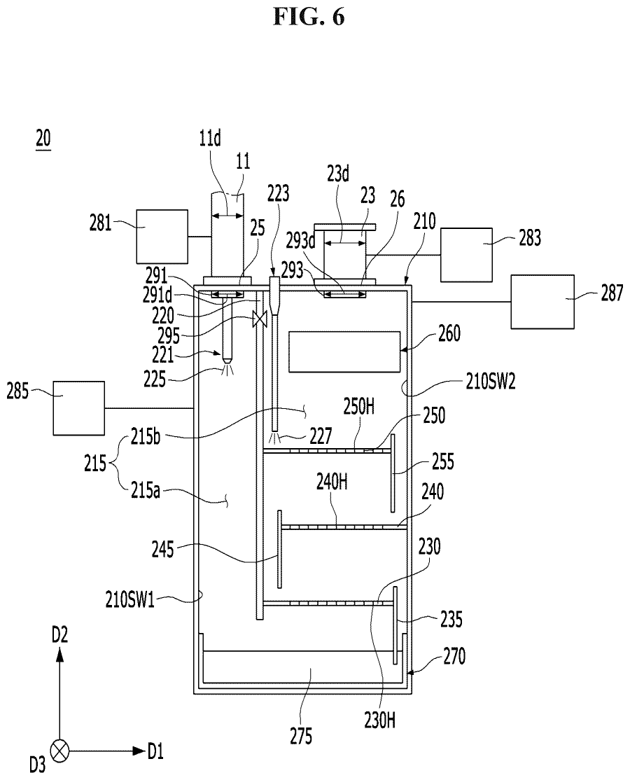

Hereinafter, scrubbing apparatuses according to some other embodiments of the present invention will be described with reference to FIGS. 6 to 11. For convenience of explanation, descriptions that overlap with the content described with reference to FIGS. 2 to 5 will be briefly explained or omitted.

FIGS. 6 to 11 are drawings for explaining the scrubbing apparatus according to some other embodiments of the present invention.

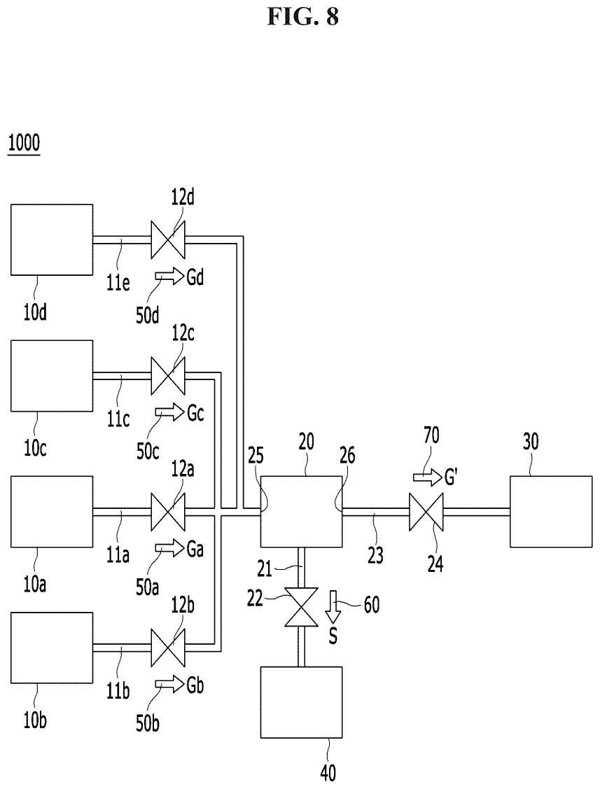

For reference, FIGS. 6, 7, 9, 10, and 11 may be cross-sectional views of scrubbing apparatuses according to some other embodiments of the present invention, and FIG. 8 may be a view of a scrubbing system including a scrubbing apparatus according to another embodiment of the present invention.

First, referring to FIG. 6, the first pressure controller 291 may be disposed at a boundary between the gas injection pipe 11 and the scrubbing chamber 210. The first pressure controller 291 may be disposed below the gas inlet port 25. That is, the first pressure controller 291 may be disposed outside the gas injection pipe 11.

Even in this case, a width 291d of the first pressure controller 291 may be equal to or less than a width 11d of the gas injection pipe 11. However, the technical scope of the present invention is not limited thereto. In some embodiments, the width 291d of the first pressure controller 291 may be greater than the width 11d of the gas injection pipe 11.

The second pressure controller 293 may be disposed at a boundary between the gas discharge pipe 23 and the scrubbing chamber 210. The second pressure controller 293 may be disposed below the gas outlet port 26. That is, the second pressure controller 293 may be disposed outside the gas discharge pipe 23.

Even in this case, a width 293d of the second pressure controller 293 may be equal to or less than a width 23d of the gas discharge pipe 23. However, the technical scope of the present invention is not limited thereto. In some embodiments, the width 293d of the second pressure controller 293 may be greater than the width 23d of the gas discharge pipe 23.

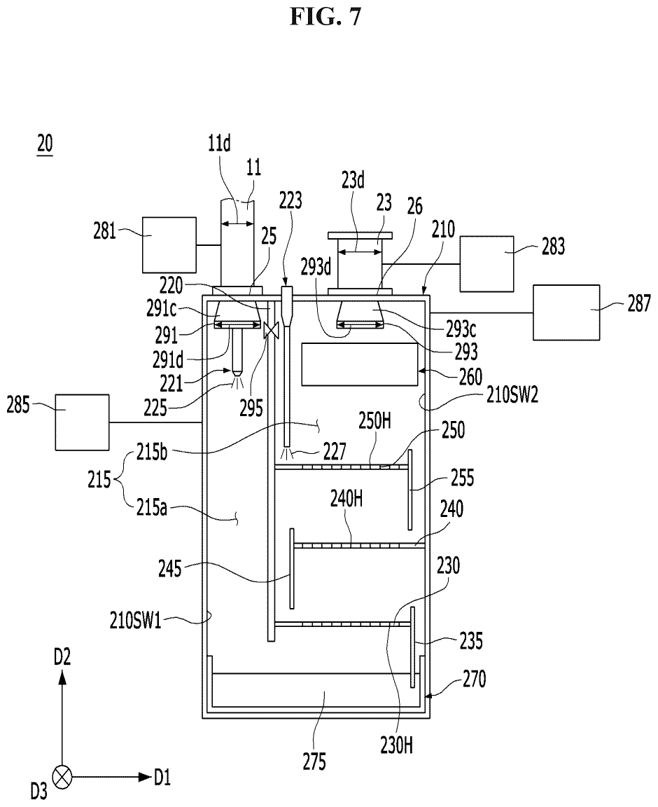

Referring to FIG. 7, the scrubbing apparatus 20 according to some embodiments further include a first connecting pipe 291c and a second connecting pipe 293c.

The first connecting pipe 291c may be disposed at a boundary between the gas injection pipe 11 and the scrubbing chamber 210. The first pressure controller 291 may be disposed below the first connecting pipe 291c.

The first connecting pipe 291c may have a structure in which its width gradually increases as it moves away from the gas injection pipe 11. Accordingly, the width 291d of the first pressure controller 291 may be greater than the width Ile of the gas injection pipe 11. The width 291d of the first pressure controller 291 may be equal to the width of the first connecting pipe 291c at a boundary between the first connecting pipe 291c and the first pressure controller 291. Therefore, energy loss caused by rotation of the first pressure controller 291 may be minimized.

The second connecting pipe 293c may be disposed at a boundary between the gas discharge pipe 23 and the scrubbing chamber 210. The second pressure controller 293 may be disposed below the second connecting pipe 293c.

The second connecting pipe 293c may have a structure in which its width gradually increases as it moves away from the gas discharge pipe 23. Accordingly, the width 293d of the second pressure controller 293 may be greater than the width 23d of the gas discharge pipe 23. The width 293d of the second pressure controller 293 may be equal to the width of the second connecting pipe 293c at a boundary between the second connecting pipe 293c and the second pressure controller 293. Therefore, energy loss caused by rotation of the second pressure controller 293 may be minimized.

Referring to FIG. 8, the process chambers connected to the scrubbing chamber 210 may be at least two or more. For example, the scrubbing system 1000 according to some other embodiments of the present invention may include first to fourth process chambers 10a, 10b, 10c, and 10d. The gas injection pipe may include first to fourth gas injection pipes 11a, 11b, 11c, and 11d. The first valve may include a first_1 valve 12a, a first_2 valve 12b, a first_3 valve 12c, and a first_4 valve 12d.

Although FIG. 8 illustrates that the scrubbing system 1000 includes four process chambers, the technical scope of the present invention is not limited thereto. The scrubbing system 1000 may include more than four process chambers, or may include fewer than four process chambers.

The first to fourth process chambers 10a, 10b, 10c, and 10d may all be connected to the scrubbing chamber (210 of FIG. 3). Specifically, the first process chamber 10a may be connected to the scrubbing chamber through the first gas injection pipe 11a. Accordingly, gas Ga discharged from the first process chamber 10a may be injected into the scrubbing chamber through the first gas injection pipe 11a.

The second process chamber 10b may be connected to the scrubbing chamber through the second gas injection pipe 11b. Accordingly, gas Gb discharged from the second process chamber 10b may be injected into the scrubbing chamber through the second gas injection pipe 11b.

The third process chamber 10c may be connected to the scrubbing chamber through the third gas injection pipe 11c. Accordingly, gas Gc discharged from the third process chamber 10c may be injected into the scrubbing chamber through the third gas injection pipe 11c.

The fourth process chamber 10d may be connected to the scrubbing chamber through the fourth gas injection pipe 11e. Accordingly, gas Gd discharged from the fourth process chamber 10d may be injected into the scrubbing chamber through the fourth gas injection pipe 11e.

In some embodiments, the number of process chambers connected to the scrubbing chamber may be variable. Specifically, the number of process chambers connected to the scrubbing chamber may be changed using the first_1 to first_4 valves 12a, 12b, 12c, and 12d. In this specification, the term “the scrubbing chamber and the process chambers are connected” may mean that gas discharged from the process chambers may be injected into the scrubbing chamber.

When the number of process chambers connected to the scrubbing chamber increases, the absolute value of the first pressure of the gas passing through the gas inlet 25 may decrease. In other words, when the number of process chambers connected to the scrubbing chamber increases, the absolute value of the first pressure of the gas passing through the gas injection pipe (11 of FIG. 3) may decrease.

In this case, the RPM of the first pressure controller may increase. This may be because, when the rotation amount of the first pressure controller increases, the absolute value of the first pressure of the gas passing through the gas injection pipe (11 of FIG. 3) increases.

Such a relationship may be expressed by the following Equation 5.

$$R 1 = A 5 {( N 1 - N 2 )}^{k} \times {e}^{B 5 ( N 1 - N 2 )} + C 5 \qquad Equation 5$$

Here, R1 may be a rotation amount and/or an RPM of the first pressure controller 291. A5, B5, C5, and k may each be constants. Specifically, C5 may be an initial rotation amount of the first pressure controller 291. The initial rotation amount may be zero; however, the technical scope of the present invention is not limited thereto. N1 may be the current number of process chambers connected to the scrubbing chamber 210. N2 may be the previous number of process chambers connected to the scrubbing chamber 210. N1 may be greater than N2. Each of k, A5, and B5 may be a rational number between 0 and 10.

According to Equation 5, as the number of process chambers connected to the scrubbing chamber 210 increases, the RPM of the first pressure controller 291 may rapidly increase. This may be to quickly increase the absolute value of the first pressure and thereby maintain the first pressure constant as the number of process chambers connected to the scrubbing chamber 210 increases. Accordingly, the scrubbing apparatus with improved reliability may be provided.

Conversely, when the number of process chambers connected to the scrubbing chamber 210 decreases, the absolute value of the first pressure of the gas passing through the gas inlet port 25 may increase. That is, when the number of process chambers connected to the scrubbing chamber 210 decreases, the absolute value of the first pressure of the gas passing through the gas injection pipe may increase. In this case, the RPM (rotations per minute) of the first pressure controller 291 may be decreased.

This may be because, when the rotation amount of the first pressure controller 291 decreases, the absolute value of the first pressure of the gas passing through the gas injection pipe 11 decreases.

Such a relationship may be expressed by the following Equation 6.

$$R 1 = A 6 {( N 2 - N 1 )}^{k} \times {e}^{- B 6 ( N 2 - N 1 )} + C 6 \qquad Equation 6$$

Here, R1 may be a rotation amount and/or an RPM of the first pressure controller 291. A6, B6, C6, and k may each be constants. Specifically, C6 may be an initial rotation amount of the first pressure controller 291. The initial rotation amount may be zero; however, the technical scope of the present invention is not limited thereto. N1 may be the current number of process chambers connected to the scrubbing chamber 210. N2 may be the previous number of process chambers connected to the scrubbing chamber 210. N2 may be greater than N1. Each of k, A6, and B6 may be a rational number between 0 and 10.

According to Equation 6, as the number of process chambers connected to the scrubbing chamber 210 decreases, the RPM of the first pressure controller 291 may rapidly decrease. This may be to quickly reduce the first pressure and thereby maintain the absolute value of the first pressure constant as the number of process chambers connected to the scrubbing chamber 210 decreases. Accordingly, the scrubbing apparatus with improved reliability may be provided.

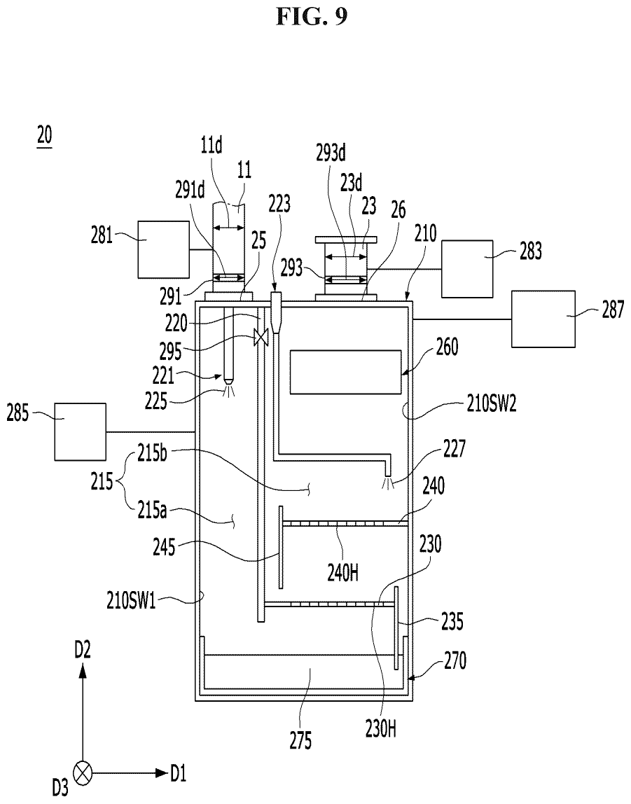

Referring to FIG. 9, the scrubbing apparatus 20 according to some embodiments may include two scrubbing plates 230 and 240. That is, the scrubbing apparatus 20 may include a first scrubbing plate 230 and a second scrubbing plate 240.

The second scrubbing plate 240 may be disposed on the first scrubbing plate 230. The second scrubbing plate 240 may be disposed on the upper surface of the first scrubbing plate 230. The first scrubbing plate 230 may be disposed on the lower surface of the second scrubbing plate 240. Another scrubbing plate may not be disposed on the upper surface of the second scrubbing plate 240.

In some embodiments, the second scrubbing solution 227 may be supplied from the solution supply nozzle 223 and discharged onto the upper surface of the second scrubbing plate 240. Specifically, the second scrubbing solution 227 may be discharged onto a region of the upper surface of the second scrubbing plate 240 adjacent to the second inner side wall 210SW2 of the scrubbing chamber 210. The second scrubbing solution 227 may be discharged onto a region of the upper surface of the second scrubbing plate 240 farthest from the second scrubbing wall 245.

The discharged second scrubbing solution 227 may flow on the upper surface of the second scrubbing plate 240 toward the second scrubbing wall 245 while the second scrubbing process is performed. The second scrubbing solution 227 may flow downward beyond the second scrubbing wall 245. At this time, the second scrubbing solution 227 does not flow downward through the second scrubbing hole 240H. The second scrubbing solution 227 flowing downward beyond the second scrubbing wall 245 may be discharged onto the upper surface of the first scrubbing plate 230.

Similarly, the second scrubbing solution 227 may flow on the upper surface of the first scrubbing plate 230 toward the first scrubbing wall 235 while the second scrubbing process is performed. At this time, the second scrubbing solution 227 does not flow downward through the first scrubbing hole 230H. The second scrubbing solution 227 may flow downward beyond the first scrubbing wall 235 to the lower part of the scrubbing chamber 210.

The scrubbing apparatus 20 illustrated in FIG. 9 includes only two scrubbing plates 230 and 240. Accordingly, the height of the scrubbing apparatus 20 in the second direction D2 may be reduced. That is, when using the scrubbing apparatus 20 according to some embodiments of the present invention, spatial efficiency may be improved.

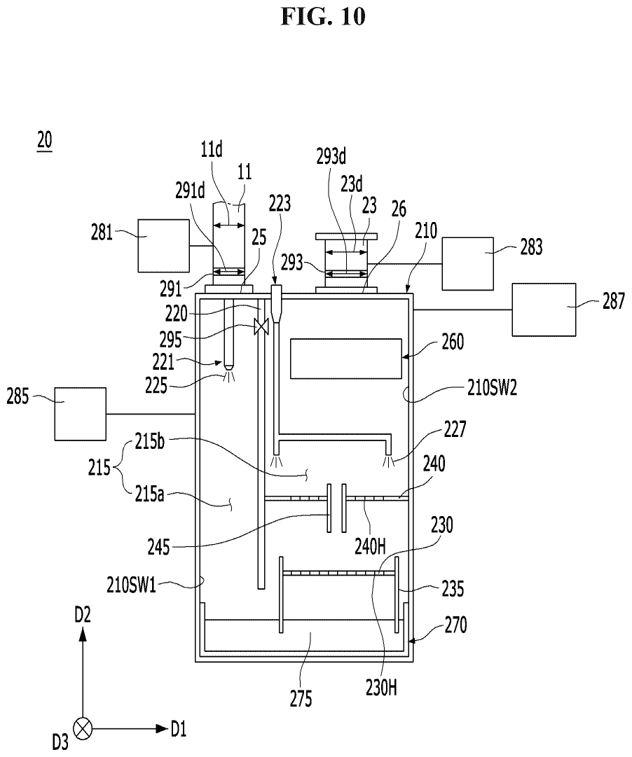

Referring to FIG. 10, in the scrubbing apparatus 20 according to some embodiments, the shape of the first scrubbing plate 230 and the shape of the second scrubbing plate 240 may differ from each other.

For example, both ends of the first scrubbing plate 230 may be spaced apart from the separating wall 220 and the second inner side wall 210SW2, respectively. Specifically, the first scrubbing plate 230 may not be in contact with or connected to either the separating wall 220 or the second inner side wall 210SW2. Although not illustrated, the first scrubbing plate 230 may be in contact with and connected to the third inner side wall and the fourth inner side wall.

A pair of first scrubbing walls 235 may be disposed at one end and the other end of the first scrubbing plate 230. Some of the pair of first scrubbing walls 235 may be interposed between the first scrubbing plate 230 and the separating wall 220. Other portions of the pair of first scrubbing walls 235 may be interposed between the first scrubbing plate 230 and the second inner side wall 210SW2.

The space between the first scrubbing wall 235 and the separating wall 220 and the space between the first scrubbing wall 235 and the second inner wall 210SW2 may each be a space through which the second scrubbing solution 227 flows downward (for example, in the second direction D2).

Both ends of the second scrubbing plate 240 may be in contact with and connected to the separating wall 220 and the second inner wall 210SW2, respectively. The second scrubbing plate 240 may have a structure with a central opening. That is, the second scrubbing plate 240 may include an opening formed in a central portion thereof and extending in the third direction D3. The opening may expose at least a portion of the upper surface of the first scrubbing plate 230. That is, the opening may overlap at least a portion of the upper surface of the first scrubbing plate 230 in the second direction D2.

A pair of second scrubbing walls 245 may be disposed at the central portion of the second scrubbing plate 240, respectively. The pair of second scrubbing walls 245 may be disposed within the opening, respectively.

A pair of second scrubbing walls 245 may be spaced apart from each other in the first direction D1, respectively. The space between the pair of second scrubbing walls 245 may be a space through which the second scrubbing solution 227 flows downward (for example, in the second direction D2).

In some embodiments, the second scrubbing solution 227 may be discharged at both ends of the second scrubbing plate 240. For example, the second scrubbing solution 227 may be discharged onto a region of the second scrubbing plate 240 adjacent to the separating wall 220 and a region of the second scrubbing plate 240 adjacent to the second inner side wall 210SW2, respectively.

The second scrubbing solution 227 discharged onto the upper surface of the second scrubbing plate 240 may flow toward the central portion of the second scrubbing plate 240. While the second scrubbing solution 227 flows toward the central portion of the second scrubbing plate 240, impurities may be dissolved into the second scrubbing solution 227. The second scrubbing solution 227 may flow over the second scrubbing wall 245 and be discharged onto the upper surface of the first scrubbing plate 230. The second scrubbing solution 227 discharged onto the upper surface of the first scrubbing plate 230 may flow toward both ends of the first scrubbing plate 230.

Although the scrubbing apparatus 20 is illustrated as including two scrubbing plates in FIG. 10, the technical scope of the present invention is not limited thereto. If the scrubbing apparatus 20 includes three scrubbing plates, the shape of the third scrubbing plate may be the same as that of the first scrubbing plate 230. The third scrubbing plate may be disposed on the second scrubbing plate 240.

If the scrubbing apparatus 20 includes four scrubbing plates, the shape of the third scrubbing plate may be the same as that of the first scrubbing plate 230, and the shape of the fourth scrubbing plate may be the same as that of the second scrubbing plate 240. The third scrubbing plate may be disposed on the second scrubbing plate 240, and the fourth scrubbing plate may be disposed on the third scrubbing plate.

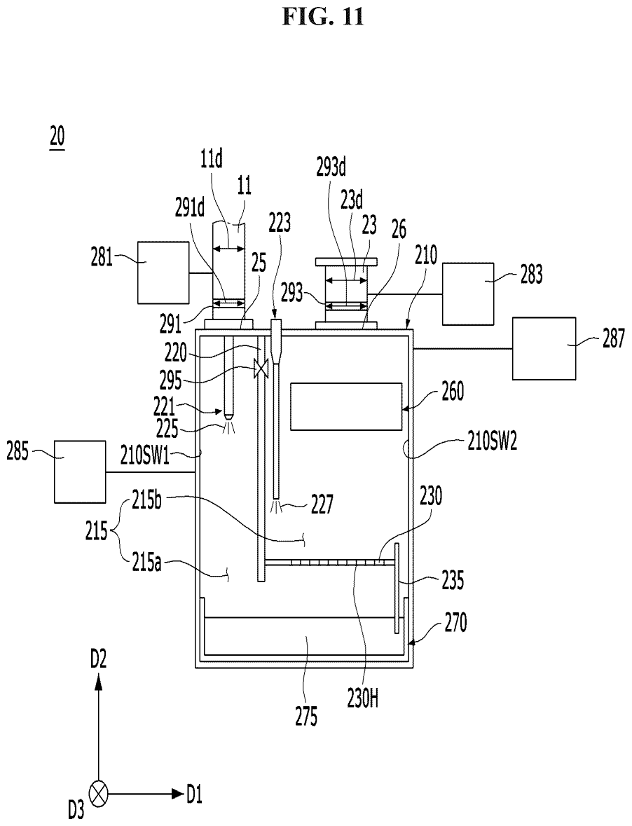

Referring to FIG. 11, the scrubbing apparatus 20 according to some embodiments may include one scrubbing plate 230. That is, the scrubbing apparatus 20 may include the first scrubbing plate 230.

In some embodiments, the second scrubbing solution 227 may be supplied from the solution supply nozzle 223 and discharged onto the upper surface of the first scrubbing plate 230. Specifically, the second scrubbing solution 227 may be discharged onto a region of the upper surface of the first scrubbing plate 230 adjacent to the separating wall 220. The second scrubbing solution 227 may be discharged onto a region of the upper surface of the first scrubbing plate 230 farthest from the first scrubbing wall 235.

The second scrubbing solution 227 may flow on the upper surface of the first scrubbing plate 230 toward the first scrubbing wall 235 while the second scrubbing process is performed. At this time, the second scrubbing solution 227 does not flow downward through the first scrubbing hole 230H. The second scrubbing solution 227 may flow downward beyond the first scrubbing wall 235 to the lower part of the scrubbing chamber 210.

The scrubbing apparatus 20 illustrated in FIG. 11 includes only one scrubbing plate 230. Accordingly, the height of the scrubbing apparatus 20 in the second direction D2 may be reduced. That is, when using the scrubbing apparatus 20 according to other embodiments of the present invention, spatial efficiency may be further improved.

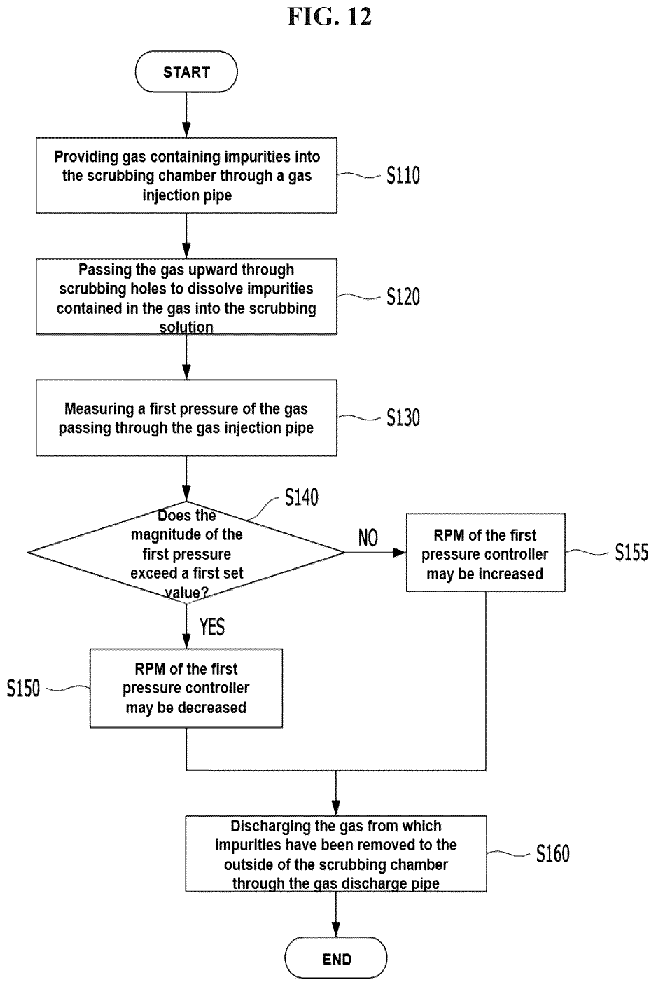

Hereinafter, a method of operating the scrubbing apparatus according to some embodiments of the present invention will be described with reference to FIGS. 12 to 15. For reference, FIGS. 12 to 15 may each be exemplary flowcharts illustrating the operation method of the scrubbing apparatus according to some embodiments of the present invention.

FIGS. 12 to 15 are drawings for explaining an operating method of a scrubbing apparatus according to some embodiments of the present invention.

First, referring to FIG. 12, the method of operating the scrubbing apparatus according to some embodiments of the present invention may include providing gas containing impurities into the scrubbing chamber through a gas injection pipe S110, passing the gas upward through scrubbing holes to dissolve impurities contained in the gas into the scrubbing solution S120, and measuring a first pressure of the gas passing through the gas injection pipe S130. Subsequently, it may be determined whether the magnitude of the first pressure exceeds a first set value S140. The magnitude of the first pressure may be the absolute value of the first pressure.

If the absolute value of the first pressure exceeds the first set value, the RPM of the first pressure controller may be decreased S150. When the RPM of the first pressure controller is decreased, the absolute value of the first pressure may decrease. If the absolute value of the first pressure does not exceed the first set value, the RPM of the first pressure controller may be increased S155. When the RPM of the first pressure controller is increased, the magnitude of the first pressure may increase. Accordingly, the first pressure may be maintained constant at the first set value.

Subsequently, the gas from which impurities have been removed may be discharged to the outside of the scrubbing chamber through the gas discharge pipe S160.

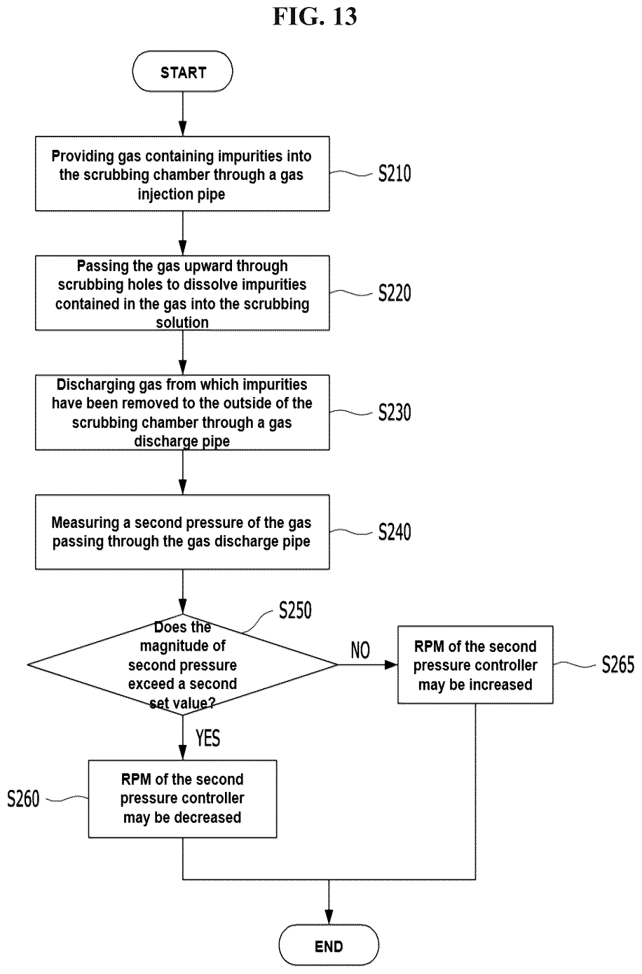

Referring to FIG. 13, the method of operating the scrubbing apparatus according to some embodiments of the present invention may include providing gas containing impurities into the scrubbing chamber through a gas injection pipe S210, passing the gas upward through scrubbing holes to dissolve impurities contained in the gas into the scrubbing solution S220, discharging gas from which impurities have been removed to the outside of the scrubbing chamber through a gas discharge pipe S230, and measuring a second pressure of the gas passing through the gas discharge pipe S240. Subsequently, it may be determined whether the magnitude of the second pressure exceeds a second set value S250. The magnitude of the second pressure may be the absolute value of the second pressure.

If the absolute value of the second pressure exceeds the second set value, the RPM of the second pressure controller may be decreased S260. When the RPM of the second pressure controller is decreased, the absolute value of the second pressure may decrease. If the absolute value of the second pressure does not exceed the second set value, the RPM of the second pressure controller may be increased S265. When the RPM of the second pressure controller is increased, the absolute value of the second pressure may increase. Accordingly, the second pressure may be maintained constant at the second set value.

By using the above operation method, the magnitude of the first pressure and the magnitude of the second pressure can be controlled to be constant. Accordingly, a scrubbing apparatus with improved reliability may be provided.

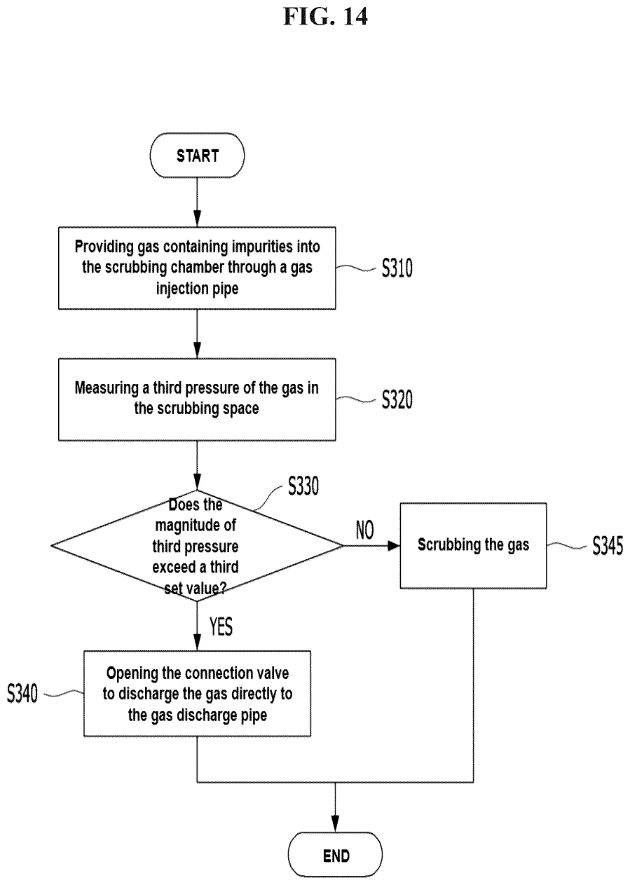

Referring to FIG. 14, the method of operating the scrubbing apparatus according to some embodiments of the present invention may include providing gas containing impurities into the scrubbing chamber through a gas injection pipe S310 and measuring a third pressure of the gas in the scrubbing space S320. Subsequently, it may be determined whether the magnitude of the third pressure exceeds a third set value S330. The magnitude of the third pressure may be the absolute value of the third pressure.

If the magnitude of the third pressure exceeds the third set value, the connection valve may be opened to discharge the gas directly to the gas discharge pipe S340. This may be to prevent malfunction of the scrubbing apparatus and the process chamber. If the magnitude of the third pressure does not exceed the third set value, the gas may be scrubbed S345.

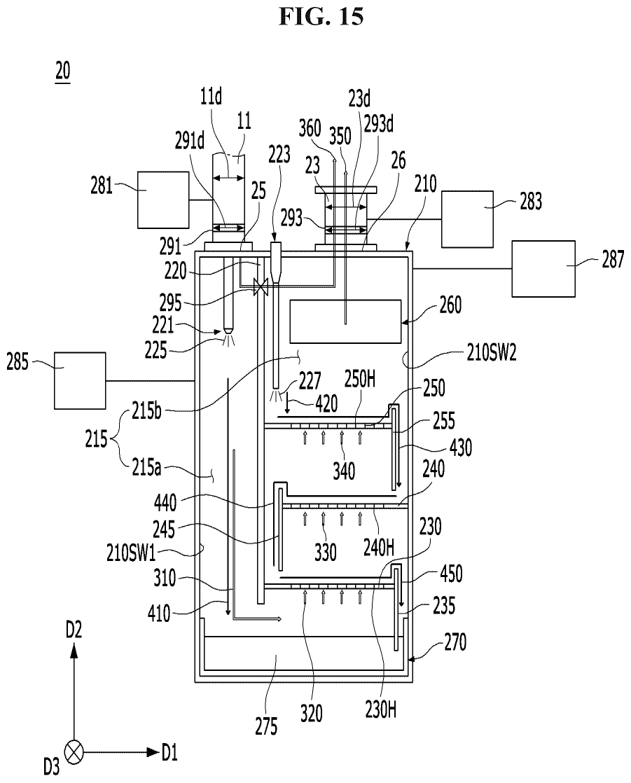

Specifically, referring to FIGS. 1 and 15, gas G containing impurities from the process chamber 10 may be supplied to the scrubbing apparatus 20. The gas G containing impurities may pass through the gas injection pipe 11 and be introduced into the scrubbing apparatus 20 through the gas inlet port 25 (see reference numeral 310).

At this time, the first pressure gauge 281 may measure a first pressure of the gas passing through the gas injection pipe 11.

The gas G containing impurities may be introduced into the first sub-space 215a. For example, the gas G containing impurities may move downward in the first sub-space 215a (see reference numeral 310).

In some embodiments, a first scrubbing process may be performed in the first sub-space 215a.

Specifically, the first scrubbing solution 225 may be supplied into the first sub-space 215a through a spray nozzle 221 (see reference numeral 410). The first scrubbing solution 225 may be water; however, the technical scope of the present invention is not limited thereto.

In FIG. 15, the first scrubbing solution 225 is illustrated as being sprayed vertically in the second direction D2; however, the technical scope of the present invention is not limited thereto.

The spray nozzle 221 may supply the first scrubbing solution 225 having small particles. As the gas G containing impurities moves downward in the first sub-space 215a, impurities contained in the gas G may be dissolved into the first scrubbing solution 225. The first scrubbing process may be a process in which impurities contained in the gas G are dissolved into the first scrubbing solution 225.

The gas G from which some impurities have been removed may be supplied to the second sub-space 215b (see reference numeral 310). A second scrubbing process may be performed in the second sub-space 215b. The second scrubbing process may be a process in which impurities contained in the gas G are dissolved into the second scrubbing solution 227.

While the second scrubbing process is performed, the solution supply nozzle 223 may supply the second scrubbing solution 227 onto the upper surface of the third scrubbing plate 250 (see reference numeral 420). The initially supplied second scrubbing solution 227 may flow downward through the third scrubbing hole 250H, the second scrubbing hole 240H, and the first scrubbing hole 230H. That is, in the initial state, the second scrubbing solution 227 may flow downward through the scrubbing holes 250H, 240H, and 230H.

While the second scrubbing process is performed, the gas G may ascend in the second direction D2. The gas G may pass through the first scrubbing hole 230H and ascend in the second direction D2.

Specifically, referring to FIG. 5, the gas G may ascend through the first scrubbing hole 230H. As the gas G ascends in the second direction D2, bubbles BBL may be formed in the second scrubbing solution 227. At the contact surface where the bubbles BBL and the second scrubbing solution 227 come into contact, impurities contained in the gas G may be dissolved into the second scrubbing solution 227.

While the second scrubbing process is performed, the second scrubbing solution 227 does not flow downward through the scrubbing holes 250H, 240H, and 230H. This may be due to the pressure of the gas G ascending through the scrubbing holes 250H, 240H, and 230H.

While the second scrubbing process is performed, the second scrubbing solution 227 may flow on the upper surface of the third scrubbing plate 250 toward the third scrubbing wall 255, and flow over the third scrubbing wall 255 onto the upper surface of the second scrubbing plate 240 (see reference numeral 430). In addition, the second scrubbing solution 227 may flow on the upper surface of the second scrubbing plate 240 toward the second scrubbing wall 245, and flow over the second scrubbing wall 245 onto the upper surface of the first scrubbing plate 230 (see reference numeral 440). Furthermore, the second scrubbing solution 227 may flow on the upper surface of the first scrubbing plate 230 toward the first scrubbing wall 235, and flow over the first scrubbing wall 235 to the lower part of the scrubbing chamber 210 (see reference numeral 450).

The first scrubbing solution 225 supplied in the first sub-space 215a may be stored in the scrubbing solution storage tank 270 after the first scrubbing process is performed. The second scrubbing solution 227 flowing over the first scrubbing wall 235 may be stored in the scrubbing solution storage tank 270 after the second scrubbing process is performed. The scrubbing solution storage tank 270 may store a scrubbing solution 275 in which impurities are dissolved. The scrubbing solution 275 in which impurities are dissolved may include the first scrubbing solution in which impurities are dissolved and the second scrubbing solution in which impurities are dissolved.

While the second scrubbing solution 227 flows in the above-described direction, the gas G may pass through the scrubbing holes 250H, 240H, and 230H and ascend in the second direction D2. As the gas G passes through the scrubbing holes 250H, 240H, and 230H, bubbles may be formed within the second scrubbing solution 227.

Specifically, the gas G may ascend through the first scrubbing hole 230H (see reference numeral 320). Subsequently, the gas G may ascend through the second scrubbing hole 240H (see reference numeral 330). Then, the gas G may ascend through the third scrubbing hole 250H (see reference numeral 340).

As the gas G ascends through the scrubbing holes 250H, 240H, and 230H, impurities may be dissolved into the second scrubbing solution 227.

Subsequently, the gas G′ from which impurities have been removed may pass through the demister 260 and be discharged to the outside of the scrubbing chamber 210 (see reference numeral 350). At this time, the second pressure gauge 283 may measure a second pressure of the gas passing through the gas discharge pipe 23.

The gas G′ discharged through the gas outlet 26 may have little or no impurities remaining.

As described above, the first pressure gauge 281 measures a first pressure of the gas passing through the gas injection pipe 11. If the absolute value of the first pressure differs from the first set value, the RPM of the first pressure controller 291 may be controlled to maintain the absolute value of the first pressure equal to the first set value.

Similarly, the second pressure gauge 283 measures a second pressure of the gas passing through the gas discharge pipe 23. If the absolute value of the second pressure differs from the second set value, the RPM of the second pressure controller 293 may be controlled to maintain the absolute value of the second pressure equal to the second set value.

The third pressure gauge 285 measures a third pressure of the gas inside the scrubbing space 215. If the absolute value of the third pressure exceeds the third set value, or if the absolute value of the third pressure is equal to the absolute value of the first pressure, or if the absolute value of the third pressure is equal to the absolute value of the second pressure, the connection valve 295 may open. In this case, the gas injected through the gas injection pipe 11 may pass through the connection valve 295 and be directly discharged to the gas discharge pipe 23 (see reference numeral 360).

Although the embodiments of the present invention have been described with reference to the attached drawings, the present invention is not limited to the embodiments described above, but can be manufactured in various different forms, and a person having ordinary skill in the art to which the present invention pertains will understand that the present invention can be implemented in other specific forms without changing the technical scope or essential features of the present invention. Therefore, it should be understood that the embodiments described above are exemplary in all respects and not restrictive.

1. A scrubbing apparatus comprising:
a scrubbing chamber defining a scrubbing space for scrubbing impurities contained in gas discharged from a process chamber;
a gas injection pipe having one end connected to the scrubbing chamber and the other end connected to the process chamber, and through which the gas is injected into the scrubbing chamber;
a gas discharge pipe connected to the scrubbing chamber, through which the gas is discharged to the outside of the scrubbing chamber;
a first scrubbing plate disposed in the scrubbing chamber;
a plurality of first scrubbing holes penetrating the first scrubbing plate;
a solution supply nozzle configured to supply a scrubbing solution onto an upper surface of the first scrubbing plate;
a first pressure gauge configured to measure a first pressure of the gas passing through the gas injection pipe; and
a first pressure controller provided at a boundary between the gas injection pipe and the scrubbing chamber or within the gas injection pipe and configured to adjust a magnitude of the first pressure,
wherein bubbles are formed on the upper surface of the first scrubbing plate as the gas ascends through the plurality of first scrubbing holes, and
wherein the impurities are dissolved in the scrubbing solution at a portion where the bubbles and the scrubbing solution come into contact.

2. The scrubbing apparatus of claim 1, wherein when an absolute value of the first pressure measured by the first pressure gauge is greater than a first set value, an RPM (rotations per minute) of the first pressure controller decreases, and
wherein when the absolute value of the first pressure measured by the first pressure gauge is less than the first set value, the RPM of the first pressure controller increases.

3. The scrubbing apparatus of claim 2, wherein the first set value is greater than 500 Pa and less than 2000 pa.

4. The scrubbing apparatus of claim 2, wherein the RPM of the first pressure controller is determined by the following Equation 1 and Equation 2:
$$R 1 = A 1 {( P 1 - {P}_{s e t 1} )}^{n} \times {e}^{- B 1 ( P 1 - {P}_{s e t 1} )} + C 1 ( P 1 > {P}_{set 1} ) \qquad [ Equation 1 ]$$
$$R 1 = A 2 {( {P}_{s e t 1} - P 1 )}^{n} \times {e}^{B 2 ( {P}_{s e t 1 - P 1} )} + C 2 ( {P}_{s e t 1} > P 1 ) \qquad [ Equation 2 ]$$
wherein R1 is a rotation amount of the first pressure controller;
A1, B1, C1, A2, B2, C2, and n are rational numbers each ranging from 0 to 10;
P1 is the first pressure;
Pₛₑₜ₁ is the first set value; and
C1 and C2 are initial rotation amounts of the first pressure controller, respectively.

5. The scrubbing apparatus of claim 2, further comprising:
a second pressure gauge configured to measure a second pressure of the gas passing through the gas discharge pipe; and
a second pressure controller provided at a boundary between the gas discharge pipe and the scrubbing chamber or within the gas discharge pipe and configured to adjust a magnitude of the second pressure,
wherein when an absolute value of the second pressure measured by the second pressure gauge is greater than a second set value, an RPM of the second pressure controller decreases, and
wherein when the absolute value of the second pressure measured by the second pressure gauge is less than the second set value, the RPM of the second pressure controller increases.

6. The scrubbing apparatus of claim 5, wherein a sum of the first set value and the second set value is equal to or greater than 1000 Pa and equal to or less than 4000 Pa.

7. The scrubbing apparatus of claim 1, wherein the scrubbing space includes a first sub-space and a second sub-space separated by a separating wall,
wherein the gas injection pipe is connected to the first sub-space, and
wherein the gas discharge pipe is connected to the second sub-space.

8. The scrubbing apparatus of claim 7, wherein the first scrubbing plate and the solution supply nozzle are provided in the second sub-space.

9. The scrubbing apparatus of claim 7, wherein the first sub-space and the second sub-space are connected to each other at a lower part of the scrubbing chamber.

10. The scrubbing apparatus of claim 7, further comprising:
a connection valve provided at an upper part of the separating wall and configured to be opened and closed; and
a third pressure gauge configured to measure a third pressure inside the first sub-space,
wherein when an absolute value of the first pressure and an absolute value of the third pressure are equal, the connection valve is opened, such that the gas injected through the gas injection pipe passes through the connection valve and is directly discharged to the outside of the scrubbing chamber through the gas discharge pipe.

11. The scrubbing apparatus of claim 7, further comprising:
a second pressure gauge configured to measure a second pressure of the gas passing through the gas discharge pipe;
a second pressure controller provided at a boundary between the gas discharge pipe and the scrubbing chamber or within the gas discharge pipe and configured to adjust a magnitude of the second pressure;
a connection valve provided at an upper part of the separating wall and configured to be opened and closed; and
a fourth pressure gauge configured to measure a third pressure inside the second sub-space,
wherein when an absolute value of the second pressure and an absolute value of the third pressure are equal, the connection valve is opened, such that the gas injected through the gas injection pipe passes through the connection valve and is directly discharged to the outside of the scrubbing chamber through the gas discharge pipe.

12. The scrubbing apparatus of claim 7, further comprising:
a connection valve provided at an upper part of the separating wall and configured to be opened and closed; and
a third pressure gauge configured to measure a third pressure inside the scrubbing space,
wherein when an absolute value of the third pressure exceeds a third set value, the connection valve is opened, such that the gas injected through the gas injection pipe passes through the connection valve and is directly discharged through the gas discharge pipe.

13. The scrubbing apparatus of claim 1, wherein a number of process chambers connected to the scrubbing chamber is variable,
wherein when the number of process chambers connected to the scrubbing chamber increases, an RPM of the first pressure controller increases, and
wherein when the number of process chambers connected to the scrubbing chamber decreases, the RPM of the first pressure controller decreases.

14. The scrubbing apparatus of claim 3, wherein an RPM of the first pressure controller is determined by the following Equation 5 and Equation 6:
$$R 1 = A 5 {( N 1 - N 2 )}^{k} \times {e}^{B 5 ( N 1 - N 2 )} + C 5 \qquad [ Equation 5 ]$$
$$R 1 = A 6 {( N 2 - N 1 )}^{k} \times {e}^{- B 6 ( N 2 - N 1 )} + C 6 \qquad [ Equation 6 ]$$
wherein R1 is a rotation amount of the first pressure controller;
A5, B5, C5, A6, B6, C6, and k are rational numbers each ranging from 0 to 10;
N1 is a current number of process chambers connected to the scrubbing chamber;
N2 is a previous number of process chambers connected to the scrubbing chamber; and
C5 and C6 are initial rotation amounts of the first pressure controller, respectively.
